(19) United States
(12) Patent Application Publication
(10) Pub. No.: US 2006/0100317 A1
(43) Pub. Date: May 11, 2006

(54) Aminoplast molding compounds for products exhibiting an improved flexibility and aminoplast products exhibiting and improved flexibility

(76) Inventors: Manfred Ratzsch, Thalheim (AT); Markus Machherndl, Leonding (AT); Peter Breiteneder, Linz (AT); Steffen Pfeiffer, Linz (AT); Hartmut Bucka, Eggendorf (AT); Sascha Kaltenbacher, Linz (AT); Rene Dicke, Linz (AT); Alisa Mujkanovic, Linz (AT)

Correspondence Address: THE WEBB LAW FIRM, P.C., 700 KOPPERS BUILDING, 436 SEVENTH AVENUE, PITTSBURGH, PA, 15219, US

(21) Appl. No.: 10/517,864

(22) PCT Filed: Jun. 12, 2003
(86) PCT No.: PCT/EP03/06173

§ 371 Date: Sep. 8, 2005

(30) Foreign Application Priority Data
Jun. 14, 2002 (AT) A902/2002
Jun. 14, 2002 (AT) A905/2002

(51) Int. Cl. B29C 47/00; C08K 3/26

(52) U.S. Cl. 524/13; 524/425

(57) ABSTRACT

An aminoplast molding compound comprised of mixtures consisting of meltable 20 to 1000-ring polytriazine ethers, in which the triazine rings are primarily linked by binding links of the —NH—CHR₂—O—R₄—O—CHR₂—NH— and —NH—CHR₂—NH— type, whereby: R₂═H, C₁-C₇-alkyl; R₄═C₂-C₁₈-alkylene, —CH(CH₃)—CH₂—<SB>_{C2-C12}—<SB>-alkylene-O—CH₂—CH(CH₃)—, —CH(CH₃)—CH₂—O—<SB>_{C2-C12}—<SB>-arylene-O—CH₂—CH(CH₃)—, —[CH₂—CH₂—O—CH₂—CH₂]ₙ—, —[CH₂—CH(CH₃)—O—CH₂—CH(CH₃)]ₙ—, —[—O—CH₂—CH₂—CH₂—CH₂—]ₙ—, —[(CH₂)₂₋₈—O—CO—<SB>_{C6-C14}—<SB>-arylene-CO—O—(CH₂)₂₋₈—]ₙ—, —[(CH₂)₂₋₈—O—CO—<SB>_{C2-C12}—<SB>-alkylene-CO—O—(CH₂)₂₋₈—]ₙ—, wherein n=1 to 200. The aminoplast molding compounds are also comprised of sequences containing siloxane groups, sequences based on the alkylene oxide adducts of melamine, phenol ether sequences based on bivalent phenols and diols, and these compounds can contain up to 50% by mass of additional reactive polymers of the ethylene-copolymer, maleic anhydride-copolymer, modified maleic anhydride-copolymer, poly(meth)acrylate, polyamide, polyester and/or polyurethane type, up to 75% by mass of fillers, up to 20% by mass of diols, and up to 5% by mass of stabilizers, UV absorbers and/or auxiliary agents.

The invention relates to amino resin moulding materials for products with improved flexibility and a process for the production of the same and amino resin products with improved flexibility and a process for the production of the same.

Amino resins like melamine formaldehyde resins or melamine urea formaldehyde resins and products made from amino resins like melamine formaldehyde resins or melamine urea formaldehyde resins [Ullmann's Encyclopedia of Industrial Chemistry (1987), Vol. A2, 130-131] are known. A disadvantage in the production of products made from melamine resins is the difficult workability according to the usual thermoresin processing methods like extrusion, injection moulding or blow moulding and also the low degree of flexibility of the same.

Low molecular melamine resin precondensates have a melting viscosity which is too low for these processing methods and can be processed into products merely as high filled moulds with long cycle times with hardening of the products (Woebucken, W., Kunststoff-Handbuch, Volume 10 “Duroplaste”, Carl Hanser Verl. Munchen 1988, Pages 266-274 ). Due to the low melting viscosity of the melamine resin precondensates melamine resin products in the form of fibres, foams or coatings made from melamine resins can only be produced using solutions of the melamine resin precondensates with hardening during the forming.

Known processes for improving the flexibility of melamine resin products are the addition of polyvinyl alcohol during the production of melamine resin fibres through spinning from solution (DE 23 64 091 B2) or the use of melamine resins which are modified with alkene diamines, alkoxyalkyl amines/dicyan diamide in the production of post forming laminates (WO 96 30 422 A1). In the production of the products with improved flexibility, however, melamine resin solutions are used.

Amino resin moulding materials which can be worked according to thermoresin processing methods into products with improved flexibility are the object of the present invention.

The object according to the invention has been achieved through amino resin moulding materials which consist of meltable 20 to 1000 nuclei polytriazine ethers and the amino resin products produced from the same,
wherein in the polytriazine ethers the triazine segments 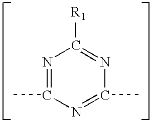
R₁═—NH₂, —NH—CHR₂—O—R₃, —NH—CHR₂—O—R₄—OH, —OH, phthalimido-, succinimido-, —NH—CHR₂—O—R₄—O—CHR₂—NH—, —NH—CHR₂—NH—, —NH—CHR₂—O—CHR₂—NH—,
R₂═H, C₁-C₇-alkyl;
R₃═C₁-C₁₈-alkyl, H;
R₄═C₂-C₁₈-alkylene, —CH(CH₃)—CH₂—O—_{C2-C12}-alkylene-O—CH₂—CH(CH₃)—, —CH(CH₃)—CH₂—O—_{C2-C12}-arylene-O—CH₂—CH(CH₃)—, —[CH₂—CH₂—O—CH₂—CH₂]ₙ—, —[CH₂—CH(CH₃)—O—CH₂—CH(CH₃)]ₙ—, —[—O—CH₂—CH₂—CH₂—CH₂—]ₙ—, —[(CH₂)₂₋₈—O—CO-_{C6-C14}-arylene-CO—O—(CH₂)₂₋₈—]ₙ—, —[(CH₂)₂₋₈—O—CO-_{C2-C12}-alkylene-CO—O—(CH₂)₂₋₈—]ₙ—, wherein n=1 to 200;
   siloxane groups containing sequences of the type 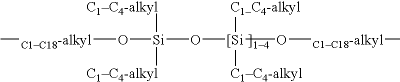
   siloxane groups containing polyester sequences of the type —[(X)ᵣ—O—CO—(Y)ₛ—CO—O—(X)ᵣ]—,
   wherein
   X═{(CH₂)₂₋₈—O—CO-_{C6-C}14-arylene-CO—O—(CH₂)₂₋₈—} or —{(CH₂)₂₋₈—O—CO-_{C2-C12}-alkylene-CO—O—(CH₂)₂₋₈—}; 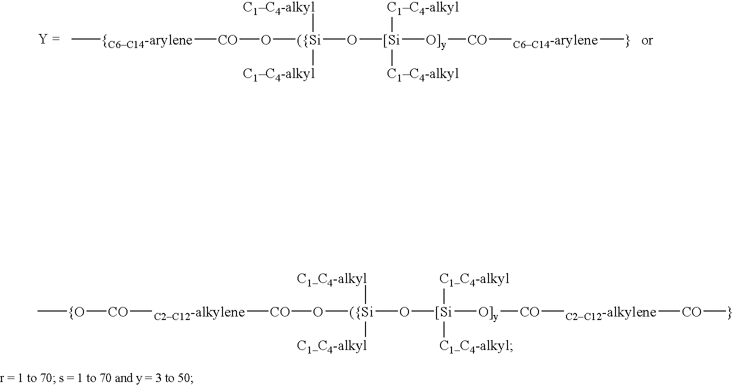
   siloxane groups containing polyether sequences of the type 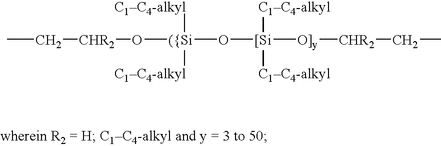
   sequences based on alkylene oxide adducts of melamine of the type 2-amino-4,6-di-_{C2-C4}-alkylene-amino-1,3,5-triazine sequences:
   phenolic ether sequences based on bivalent phenols and C₂-C₈ diols of the type -_{C2-C8}-alkylene-O-_{C6-C18}-arylene-O-_{C2-C8}-alkylene sequences;
      are combined through bridging members —NH—CHR₂—O—R₄—O—CHR₂—NH— and —NH—CHR₂—NH— as well as optionally —NH—CHR₂—O—CHR₂—NH— to 20 to 1000 nuclei polytriazine ethers with linear and/or branched structure,
wherein in the polytriazine ethers the molar ratio of the substituents is R₃:R₄=20:1 to 1:20,
the proportion of the combinations of the triazine segments through bridging members —NH—CHR₃—O—R₄—O—CHR₃—NH— is 5 to 95 mol %,
and wherein the amino resin moulding materials can contain up to 75 mass % fillers and/or adsorber materials, up to 50 mass % further reactive polymers of the type ethylene copolymers, maleic acid anhydride copolymers, modified maleic acid anhydride copolymers, poly(meth)acrylates, polyamides, polyesters and/or polyurethanes, up to 20 mass % diols of the type HO—R₄—OH and up to 5 mass % stabilisers, UV absorbers and/or auxiliary substances.

The terminal triazine segments arising in the polytriazine ethers of the amino resin moulding materials according to the invention are triazine segments of the structure 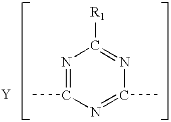
Y═—NH—CHR₂—O—R₃, —NH—CHR₂—O—R₄—OH
R₁═—NH₂, —NH—CHR₂—O—R₃, —NH—CHR₂O—R₄—OH, —OH, phthalimido-. succinimido-, —NH—CHR₂—O—R₄—O—CHR₂—NH—, —NH—CHR₂—NH—, —NH—CHR₂—O—CHR₂—NH—,
R₂═H, C₁-C₇-alkyl;
R₃═C₁-C₁₈-alkyl, H;
R₄═C₂-C₁₈-alkylene, —CH(CH₃)—CH₂—O—_{C2-C12}-alkylene-O—CH_{2—CH(CH}₃)—, —CH(CH₃)—CH₂—O—_{C2-C12}-arylene-O—CH₂—CH(CH₃)—, —[CH₂—CH₂—O —CH₂—CH₂]ₙ—, —[CH₂—CH(CH₃)—O—CH₂—CH(CH₃)]ₙ—, —[—O—CH₂—CH₂—CH₂—CH₂—]ₙ—, —[(CH₂)₂₋₈—O—CO-_{C6-C14}-arylene-CO—O—(CH₂)₂₋₈—]ₙ—, —[(CH₂)₂₋₈—O—CO-_{C2-C12}-alkylene-CO—O—(CH₂)₂₋₈—]ₙ—, wherein n=1 to 200;
   siloxane groups containing sequences of the type 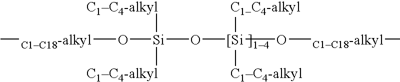
   siloxane groups containing polyester sequences of the type —[(X)ᵣ—O—CO—(Y)ₛ—CO—O—(X)ᵣ]—,
   wherein
   X═{(CH₂)₂₋₈—O—CO-_{C6-C14}-arylene-CO—O—(CH₂)₂₋₈—} or —{(CH₂)₂₋₈—O—CO-_{C2-C12}-alkylene-CO—O—(CH₂)₂₋₈—}; 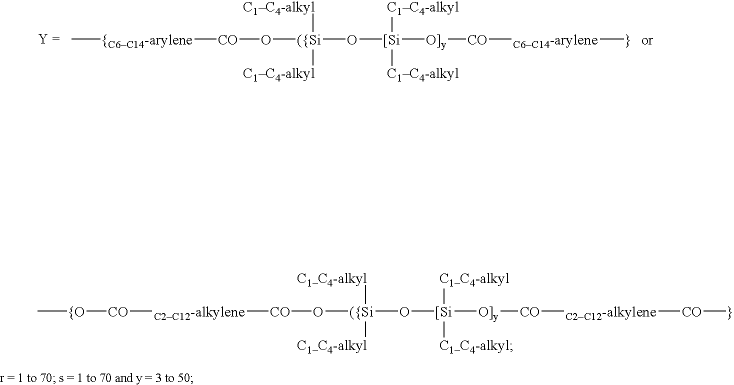
siloxane groups containing polyether sequences of the type 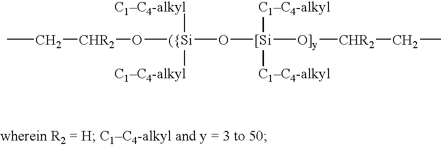
sequences based on alkylene oxide adducts of melamine of the type 2-amino-4,6-di-_{C2-C4}-alkyene-amino-1,3,5-triazine sequences:
phenolic ether sequences based on bivalent phenols and C₂-C₈-diols of the type -_{C2-C8}-alkylene-O-_{C6-C18}-arylene-O-_{C2-C8}-alkylene sequences;

The amino resin moulding materials can be present in the form of cylindrical, lens-shaped, pastille-shaped or spherical particles with an average diameter of 0.5 to 8 mm.

Preferred polytriazine ethers in amino resin moulding materials are 30 to 300 nuclei polytriazine ethers which contain 30 to 300 triazine cycles in the macromolecule.

Preferable in the amino resin moulding materials as polytriazine ethers in the mixtures are polytriazine ethers with R₂═H.

The mixtures of polytriazine ethers in the amino resin moulding materials can be mixtures of polytriazine ethers with the same or different substituent
R₁═—NH₂, —NH—CHR₂—O—R₃, —NH—CHR₂—O—R₄—OH, —OH, phthalimido-. succinimido- —NH—CHR₂—O—R₄—O—CHR₂—NH—, —NH—CHR₂—NH—, —NH—CHR₂—O—CHR₂—NH—.

Examples for suitable fillers which can be contained in the amino resin moulding materials up to 75 mass % are Al₂O₃, Al(OH)₃, barium sulphate, calcium carbonate, glass balls, silica, mica, quartz dust, slate dust, micro hollow spheres, carbon black, talc, stone dust, wood flour, cellulose powder and/or shell and nucleus dusts like peanut shell dust or olive stone dust. Preferred as fillers are layer silicates of the type montmorillonite, bentonite, kaolinite, muscovite, hectorite, fluorohectorite, kanemite, revdite, grumantite, llerite, saponite, beidelite, nontronite, stevensite, laponite, taneolite, vermiculite, halloysite, volkonskoite, magadite, rectorite, kenyaite, sauconite, boron fluorophlogopites and/or synthetic smectites.

Examples for reactive polymers of the type ethylene copolymers which can be contained in the amino resin moulding materials up to 50 mass % are part saponified ethylene vinyl acetate copolymers, ethylene butyl acrylate acrylic acid copolymers, ethylene hydroxy ethyl acrylate copolymers or ethylene butyl acrylate glycidyl methacrylate copolymers.

Examples for reactive polymers of the type maleic acid anhydride copolymers which can be contained in the amino resin moulding materials up to 50 mass % are C₂-C₂₀-olefine-maleic acid anhydride copolymers or copolymers of maleic acid anhydride and C₈-C₂₀-vinyl aromates.

Examples for the C₂-C₂₀-olefine components which can be contained in the maleic acid anhydride copolymers are ethylene, propylene, butene-1, isobutene, diisobutene, hexene-1, octene-1, heptene-1, pentene-1, 3-methylbutene-1, 4-methylpentene-1, methylethylpentene-1, ethylpentene-1, ethylhexene-1, octadecene-1 and 5,6-dimethyinorbornene.

Examples for the C₈-C₂₀-vinyl aromate components which can be contained in the maleic acid anhydride copolymers are styrene, α-methylstyrene, dimethylstyrene, isopropenylstyrene, p-methylstyrene und vinyl biphenyl.

The modified maleic acid anhydride copolymers which are optionally contained in the amino resin moulding materials are preferably partially or fully esterified, amidified or imidified maleic acid anhydride copolymers.

Particularly suitable are modified copolymers of maleic acid anhydride and C₂-C₂₀-olefines or C₈-C₂₀-vinyl aromates with a molar ratio of 1:1 to 1:9 and molar mass weight means of 5000 to 500000 which have been converted with ammonia, C₁-C₁₈-monoalkyl amines, C₆-C₁₈-aromatic monoamines, C₂-C₁₈-monoamino-alcohols, monoaminated poly(C₂-C₄-alky)oxides of a molar mass of 400 to 3000, and/or monoetherified poly(C₂-C₄-alky)oxides of a molar mass of 100 to 10000 wherein the molar ratio anhydride groups copolymers/ammonia, amino groups C₁-C₁₈-monoalkyl amines, C₆-C₁₈-aromatic monoamines, C₂-C₁₈-monoamino-alcohols and monoaminated poly(C₂-C₄-alkylene)oxide and/or hydroxy groups poly(C₂-C₄-alkylene)oxide is 1:1 to 20:1.

Examples for reactive polymers of the type poly(meth)acrylates which can be contained in the amino resin moulding materials of up to 50 mass % are copolymers based on functional unsaturated meth(acrylate)monomers like acrylic acid, hydroxyethyl acrylate, glycidyl acrylate, methacrylic acid, hydroxybutyl methacrylate, or glycidyl methacrylate and non-functional unsaturated (meth)acrylate monomers like ethyl acrylate, butyl acrylate, ethylhexyl acrylate, methyl methacrylate, ethyl acrylate and/or butyl methacrylate and/or C₈-C₂₀-vinyl aromates. Copolymers based on methacrylic acid, hydroxyethyl acrylate, methyl methacrylate and styrene are preferable.

Examples for reactive polymers of the type polyamides which can be contained in the amino resin moulding materials up to 50 mass % are polyamide-6, polyamide-6,6, polyamide-11, polyamide-12, polyamino-amides from polycarbonic acids and polyalkylene amines and the corresponding methoxylated polyamides.

Examples for reactive polymers of the type polyester which can be contained in the amino resin moulding materials up to 50 mass % are polyesters with molar masses of 2000 to 15000 from saturated dicarbonic acids like phthalic acid, isophthalic acid, adipic acid and/or succinic acid, unsaturated dicarbonic acids like maleic acid, fumaric acid and/or itaconic acid and diols like ethylene glycol, butane diol, neopentyl glycol and/or hexane diol. Preferable are branched polyesters based on neopentyl glycol, trimethylol propane, isophthalic acid and azelaic acid.

Examples for reactive polymers of the type polyurethanes which can be contained in the amino resin moulding materials up to 50 mass % are untreated polyurethanes based on toluyl diisocyanate, diphenyl methane diisocyanate, butane diisocyanate and/or hexane diisocynate as diisocyanate components and butane diol, hexane diol and/or polyalkylene glycols as diol components with molar masses of 2000 to 30000.

Examples for suitable stabilisers and UV absorbers which can be contained in the amino resin moulding materials up to 2 mass % are piperidine derivatives, benzophenone derivatives, benzotriazol derivatives, triazine derivatives and/or benzofuranone derivatives.

Examples for suitable auxiliary substances which can be contained in the amino resin moulding materials up to 2 mass % are latent hardening agents such as ammonium sulphate and/or ammonium chloride and/or auxiliary processing agents such as calcium stearate, magnesium stearate and/or wax.

According to the invention the amino resin moulding materials are produced according to a process wherein mixtures which consist of meltable 20 to 1000 nuclei polytriazine ethers,
wherein in the polytriazine ethers the triazine segments 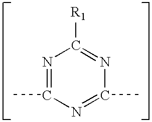
R₁═—NH₂, —NH—CHR₂—O—R₃, —NH—CHR₂—O—R₄—OH, —OH, phthalimido-. succinimido-, —NH—CHR₂—O—R₄—O—CHR₂—NH—, —NH—CHR₂—NH—, —NH—CHR₂—O—CHR₂—NH—,
R₂═H, C₁-C₇-alkyl;
R₃═C₁-C₁₈-alkyl, H;
R₄═C₂-C₁₈-alkylene, —CH(CH₃)—CH₂—O-_{C2-C12}-alkylene-O—CH₂—CH(CH₃)—, —CH(CH₃)—CH₂—O-_{C2-C12}-arylene-O—CH₂—CH(CH₃)—, —[CH₂—CH₂—O—CH₂—CH₂]ₙ—, —[CH₂—CH(CH₃)—O—CH₂—CH(CH₃)]ₙ—, —[—O—CH₂—CH₂—CH₂—CH₂—]ₙ—, —[(CH₂)₂₋₈—O—CO-_{C6-C14}-arylene-CO—O—(CH₂)₂₋₈—]ₙ—, —[(CH₂)₂₋₈—O—CO-_{C2-C12}-alkylene-CO—O—(CH₂)₂₋₈—]ₙ—, wherein n=1 to 200;
   siloxane groups containing sequences of the type 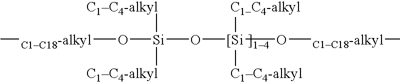
   siloxane groups containing polyester sequences of the type —[(X)ᵣ—O—CO—(Y)ₛ—CO—O—(X)ᵣ]—,
   wherein
   X═{(CH₂)₂₋₈—O—CO-_{C6-C14}-arylene-CO—O—(CH₂)₂₋₈—} or —{(CH₂)₂₋₈—O—CO-_{C2-C12}-alkylene-CO—O—(CH₂)₂₋₈—}; 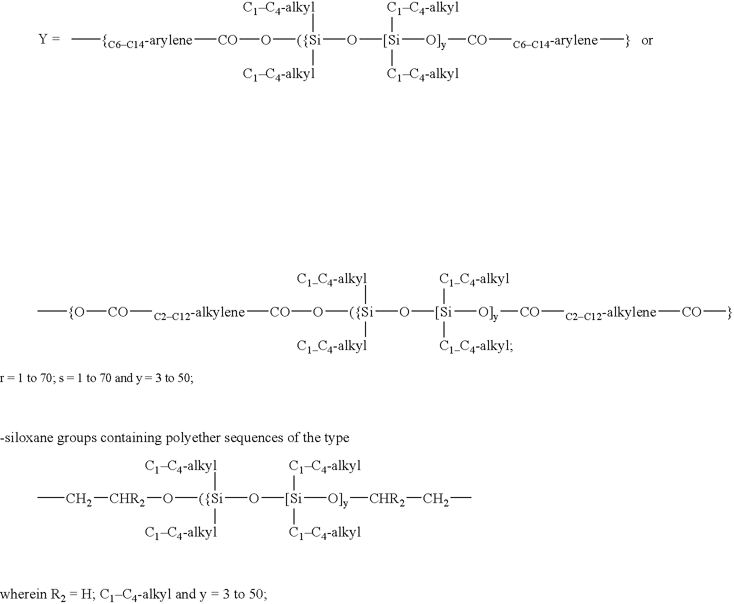
   sequences based on alkylene oxide adducts of melamine of the type 2-amino-4,6-di-_{C2-C4}-alkylene-amino-1,3,5-triazine sequences:
   phenolic ether sequences based on bivalent phenols and C₂-C₈ diols of the type -_{C2-C18}-alkylene-O-_{C6-C18}-arylene-O-_{C2-C8}-alkylene sequences;
      are combined through bridging members —NH—CHR₂—O—R₄—O—CHR₂—NH— and —NH—CHR₂—NH— and optionally —NH—CHR₂—O—CHR₂—NH— to 20 to 1000 nuclei polytriazine ethers with linear and/or branched structure,
wherein in the polytriazine ethers the molar ratio of the substituents is R₃:R₄=20:1 to 1:20,
the proportion of the combinations of the triazine segments through bridging members —NH—CHR₃—O—R₄—O—CHR₃—NH— is 5 to 95 mol %,
and wherein the amino resin moulding materials can contain up to 75 mass % fillers, up to 50 mass % further reactive polymers of the type ethylene copolymers, maleic acid anhydride copolymers, modified maleic acid anhydride copolymers, poly(meth)acrylates, polyamides, polyesters and/or polyurethanes, up to 20 mass % diols of the type HO—R₄—OH and up to 2 mass % stabilisers, UV absorbers and/or auxiliary substances,
   are produced according to a multi-step process wherein
in the first step of the process precondensates of C₁-C₈-aldehydes and triazine derivatives of the structure 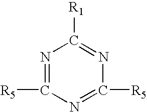
R₁═—NH₂, —NH—CHR₂—OH, —OH, phthalimido-. succinimido-,
R₂═H, C₁-C₇-alkyl;
R₅═—NH—CHR₂—OH
   are etherified through conversion with C₁-C₈ alcohols in neutral to weak acid medium at 25 to 150° C. and 0.1 to 5 bars and the substituted triazine derivatives are conditioned during standing times of 5 to 15 min at 150 to 250° C. and 0.1 to 15 bars wherein salts formed can be separated off while maintaining a pH value of 7 to 10 in that the melt of the amino triazine ethers is dissolved at 70 to 150° C. in 70 to 150 mass %, in relation to the amino triazine ethers, C₃ to C₆ alcohols, insoluble proportions are separated off after cooling to 15 to 40° C., and the added C₃ bis C₆ alcohols are vaporised at 70 to 140° C. to a remaining content of 5 to 20 mass %,
in the second step of the process the obtained C₁-C₈-alkyl-oxa-C₁-C₈-alkylene-amino-substituted triazine derivatives, through partial transethification with diols of the type HO—R₄—OH and/or partial conversion with bisepoxides of the type 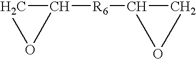
wherein R_{4 C}₂-C₁₈-alkylene, —[CH₂—CH₂—O—CH₂—CH₂]ₙ—, —[CH₂—CH(CH₃)—O—CH₂—CH(CH₃)]ₙ—, —[—O—CH₂—CH₂—CH₂—CH₂—]ₙ—, —8 (CH₂)₂₋₈—O—CO-_{C6-C14}-arylene-CO—O—(CH₂)₂₋₈—]ₙ—, —[(CH₂)₂₋₈—O—CO-_{C2-C12}-alkylene-CO—O—(CH₂)₂₋₈—]ₙ—, wherein n=1 to 200;
   siloxane groups containing sequences of the type 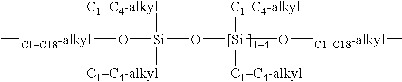
   siloxane groups containing polyester sequences of the type —[(X)ᵣ—O—CO—(Y)ₛ—CO—O—(X)ᵣ]—,
   wherein
   X═{(CH₂)₂₋₈—O—CO-_{C6-C14}-arylene-CO—O—(CH₂)₂₋₈—} or —{(CH₂)₂₋₈—O—CO_{C2-C12}-alkylene-CO—O—(CH₂)₂₋₈—}; 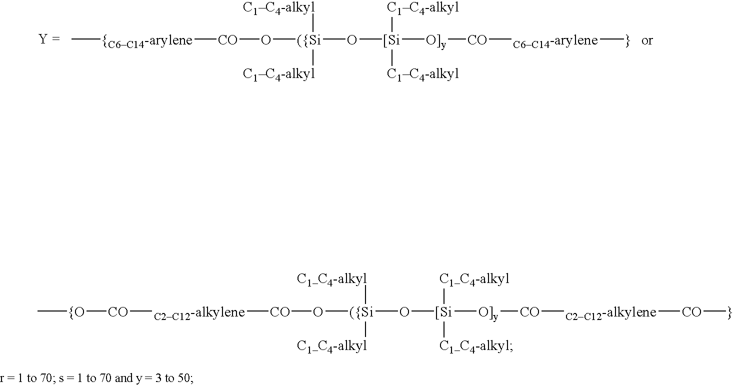
   siloxane groups containing polyether sequences of the type 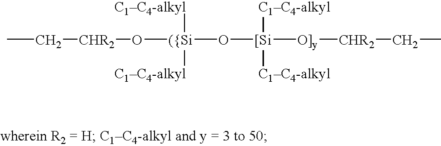
   sequences based on alkylene oxide adducts of melamine of the type 2-amino-4,6-di-_{C2-C4}-alkylene-amino-1,3,5-triazine sequences:
   phenolic ether sequences based on bivalent phenols and C₂-C₈ diols of the type -_{C2-C8}-alkylene-O-_{C6-C18}-arylene-O-_{C2-C8}-alkylene sequences;
and R₆═—CH₂—O-_{C2-C12}-alkylene-O—CH₂—, —CH₂—O-_{C6-C14}-arylene-O—CH₂—,
   and wherein in the partial conversion with diols and/or bisepoxides mixtures can be used which contain up to 70 mass % C₅-C₁₈ alcohols,
   are converted into the corresponding substituted triazine derivatives with standing times of 1 to 60 min. with distilling off of C₁-C₈ alcohols at 60 to 250° C./0.05 to 1 bar wherein through the molar ratio C₁-C₈-alkyl-oxa-C₁-C₈-alkylene-amino-groups/diol used and/or bisepoxide used of 20:1 to 1.1:1 a partial re-ethering of the C₁-C₈ alkyl ether groups of the C₁-C₈-alkyl-oxa-C₁-C₈-alkylene-amino-triazines is achieved,
   in the third step of the process for the further condensation of the amino triazine ether to polytriazine ethers the melt obtained which contains the etherified amino triazine derivatives and proportions of polytriazine ethers and diol which has not been converted/separated off and furthermore can contain C₅-C₁₈ alcohols is dosed into a kneader, converted with a standing time of 2 to 12 min at 140 to 220° C. with degassing and the polytriazine ethers are removed and granulated wherein before dosing into the kneader the melt can be exposed to tempering of 20 to 120 min at 70 to 140° C., up to 75 mass % fillers, further reactive polymers of the type ethylene copolymers, maleic acid anhydride copolymers, modified maleic acid anhydride copolymers, poly(meth)acrylates, polyamides, polyesters and/or polyurethanes and up to 2 mass %, respectively in relation to the polytriazine ethers, stabilisers, UV absorbers and/or auxiliary substances can be added to the melt and the melt can be subjected to melt filtration before removal.

The precondensates of triazine derivatives and C₁-C₈ aldehydes used in the first step of the process are precondensates which as C₁-C₈ aldehyde components contain in particular formaldehyde, acetal dehyde and/or trimethylol acetaldehyde and as a triazine derivative in particular melamine. Particularly preferable are precondensates of melamine and formaldehyde with a molar ratio melamine/formaldehyde 1:2.5 to 1:3.5.

Suitable precondensates of triazine derivatives and C₁-C₈ aldehydes which can be used in the first step of the process are furthermore precondensates which as a triazine derivative contain melamine resin ethers, phthalimido-substituted triazines like N-(4,6-diamino-(1,3,5-triazine-2-yl)-phthalimide or succinimido-substituted triazines like 2,4-diamino-6-succinimido-1,3,5-triazine. As succinimido-substituted triazines alkenyl-substituted imidotriazine derivatives of the formula: 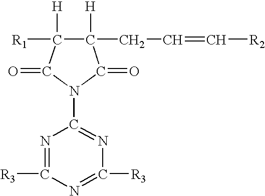
wherein
R₁═H, —CH₃, —C₂H₅,
R₂═H, C₁-C₁₅-alkyl, C₁-C₁₅-alkyloxa, cyclopentyl, cyclohexyl, C₆-C₁₂-arylene, C₆-C₁₂-arylene-oxa, cyano, carboxy, —[CH₂—]₁₋₁₃—CH═CH₂,
R₃═—NH₂, —NH—CHR₄—OR₄
R₄═H, C₁-C₇-alkyl,
   are likewise suitable.

Examples for alkenyl-substituted imidotriazine derivatives wherein the substituent is R₁═H are 2-butenyl-2-succinimido-4,6-diamino-1,3,5-triazine, 2-dodecenyl-2-succinimido-4,6-diamino -1,3,5-triazine or 2-octenyl-2-succinimido-4,6-diamino-1,3,5-triazine.

Examples for diols of the type HO—R₄—OH wherein R₄═C₂-C₁₈-alkylene are ethylene glycol, butane diol, octane diol, dodecane diol and octadecane diol.

Examples for diols of the type HO—R₄—OH wherein R₄═—[CH₂—CH₂—O—CH₂—CH₂]ₙ— and n=1-200 are polyethylene glycols with molar masses of 500 to 5000.

Examples for diols of the type HO—R₄—OH wherein R₄═—[CH₂—CH(CH₃)—O—CH₂—CH(CH₃)]ₙ— and n=1-200 are polypropylene glycols with molar masses of 500 to 5000.

Examples for diols of the type HO—R₄—OH wherein R₄═—[—O—CH₂—CH₂—CH₂—CH₂—]ₙ— and n=1-200 are polytetrahydrofuranes with molar masses of 500 to 5000.

Examples for diols of the type HO—R₄—OH wherein R₄═—[(CH₂)₂₋₈—O—CO-_{C6-C14}-arylene-CO—O—(CH₂)₂₋₈—]ₙ— are esters and polyesters based on saturated dicarbonic acids like terephthalic acid, isophthalic acid or naphthaline dicarbonic acid and diols like ethylene glycol, butane diol, neopentyl glycol and/or hexane diol. As an ester bis(hydroxyethyl)terephthalate is preferred.

Examples for diols of the type HO—R₄—OH wherein R₄═—[(CH₂)₂₋₈—O—CO-_{C2-C12}-alkylene-CO—O—(CH₂)₂₋₈—]ₙ are polyesters based on saturated dicarbonic acids like adipic acid and/or succinic acid, unsaturated dicarbonic acids like maleic acid, fumaric acid and/or itaconic acid and diols like ethylene glycol, butane diol, neopentyl glycol and/or hexane diol.

Examples for diols of the type HO—R₄—OH wherein R₄=siloxane groups containing sequences of the type 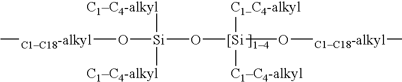
are 1,3-bis(hydroxybutyl)tetramethyl disiloxane and 1,3-bis(hydroxyoctyl)tetraethyl disiloxane.

Examples for polyester sequences with siloxane groups containing diols of the type HO—R₄—OH wherein R₄═—[(X)ᵣ—O—CO—(Y)ₛ—CO—O—(X)ᵣ]—,
wherein
X═{(CH₂)₂₋₈—O—CO-_{C6-C1}-arylene-CO—O—(CH₂)₂₋₈—} or —{(CH₂)₂₋₈—O—CO-_{C2-C12}-alkylene-CO—O—(CH₂)₂₋₈—}; 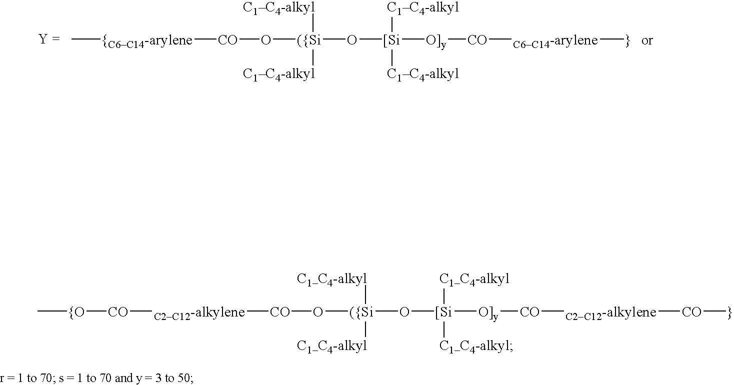
   are hydroxyl end group containing polyesters based on aromatic C₆-C₁₄-arylene-dicarbonic acids like terephthalic acid or naphthalene dicarbonic acid, aliphatic C₂-C₁₂-alkylene dicarbonic acids like adipic acid, maleic acid or pimelic acid, diols like ethylene glycol, butane diol, neopentyl glycol or hexane diol and siloxanes like hexamethyl disiloxanes or (α,ω-dihydroxy polydimethyl siloxane.

Examples for siloxane groups containing polyether diols HO—R₄—OH wherein R₄ polyether sequences of the type 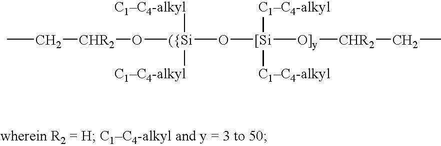
are polyether diols based on siloxanes like hexamethyl disiloxane or α,ω-dihydroxypolydimethyl siloxane and alkylene oxides like ethylene oxide or propylene oxide.

Examples for diols based on alkylene oxide adducts of melamine of the type 2-amino-4,6-bis(hydroxy-_{C2-C4}-alkylene-amino)-1,3,5-triazine are diols based on melamine and ethylene oxide or propylene oxide.

Examples for phenolic ether diols based on bivalent phenols and C₂-C₈ diols of the type bis(hydroxy-_{C2-C8}-alkylene-O-)_{C6-C18}-arylene are ethylene oxide adducts or propylene oxide adducts to diphenylol propane.

Besides diols as polyvalent alcohols in the process according to the invention for the production of amino resin moulding materials both trivalent alcohols like glycerin or tetravalent alcohols like erythrite or mixtures thereof with bivalent alcohols can be used. The extent of the conversion of the hydroxy groups in the partial transetherification in the second step of the process and the condensation in the third step of the process is effected as with the use of bifunctional alcohols.

Examples or bisepoxides of the type 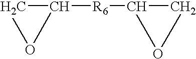
wherein R₆—CH₂—O-_{C2-C12}-alkylene-O—CH₂— or —CH₂—O-_{C6-C14}-arylene-O—CH₂—, are ethylene glycol diglycide ethers, octane diol diglycide ethers, hydrochinone diglycide ethers and diphenylol propane diglycide ethers.

Examples for C₅-C₁₈ alcohols which can be converted in mixtures with diols and/or bisepoxides in the first step of the process with the C₁-C₄-alkyl-oxa-C₁-C₈-alkylene-amino-substituted triazine derivatives are amyl alcohol, hexenyl alcohol, octyl alcohol and stearyl alcohol.

For performing the first step of the process agitation reactors with bottom outlet and decreasing cooler are suitable as reactors. Preferred reaction conditions are reaction temperatures in the range of 25 to 120° C. at 0.1 to 5 bars.

The catalysis of the etherification with C₁-C₈ alcohols in the first step of the process can be performed as homogenous catalysis in the presence of soluble ionic catalysts or as heterogeneous catalysis in the presence of ion exchangers or zeolites.

Examples for suitable acid catalysts in etherification are hydrochloric acid, phosphoric acid, nitric acid, sulphuric acid, formic acid, acetic acid, oxalic acid, p-toluol sulphonic acid, phthalic acid anhydride and maleic acid anhydride.

If the etherification in the first step of the process is effected with homogenous catalysis with hydrochloric acid as an acid catalyst alcoholic solutions of alkali metal hydroxides are preferably used for the neutralisation of the reaction mixture. Pressurised suction devices are suitable for separating off the precipitated salts. The vaporisation of the remaining content of C₁-C₈ alcohols can be effected in continuous film vaporisers with discharge worm.

Examples for suitable ion exchanging resins as heterogeneous catalysts are chloromethylated and trimethylamine-aminated copolymers of styrene and divinyl benzene, sulphonated copolymers of styrene and divinyl benzene and m-phenylene diamine formaldehyde copolymers.

The advantage of using ion exchanging resins is that with heterogeneous catalysis it is possible to dispense with all steps of the process which contain the neutralisation and separation of salts.

A preferred embodiment of the process for the production of amino resin moulding materials consists in that in the first step of the process the etherification of the precondensates is effected with C₁-C₈ alcohols in the presence of 10 to 300 mass %, in relation to the dry substance of the precondensates used, molecular sieves.

Examples for suitable molecular sieves are natural or synthetic zeolites; additions of more than 100 mass %, in relation to the dry substance of the precondensates used, of molecular sieves in the etherification are advantageous if aqueous solutions of melamine resin precondensates are used.

In the second step of the process the partial conversion of C₁-C₄-alkyl-oxa-C₁-C₈-alkylenene-amino-substituted triazine derivatives with diols and/or bisepoxides is effected according to the invention at temperatures in the range of 60 to 250° C. Falling film vaporisers or kneaders are suitable as reactors.

The preferred temperature range for the catalytic partial re-etherification of the C₁-C₄-alkyl-oxa-C₁-C₈-alkylene-amino-substituted triazine derivatives in the presence of strong acids lies at temperatures in the region of 100-175° C.

In the thermal partial re-etherification of C₁-C₄-alkyl-oxa-C₁-C₈-alkylene-amino-substituted triazine derivatives in the second step of the process the preferred temperature range is 150-250° C., in particular 180 to 230° C.

Examples for acid catalysts which can be used in the catalytic re-etherification are p-toluol sulphonic acid and/or dicarbonic acid anhydrides like phthalic acid anhydride, maleic acid anhydride, itaconic acid anhydride or Succinic acid anhydride.

For the partial re-etherification of the etherified melamine resin precondensates with diols it is advantageous to set the pH value of the alcohol to pH=2 to 7.

If in the second step of the process during the preparation of the etherified precondensate water and diol which has not been converted and optionally further reactants from the neutralised reaction deposit which have not been converted are separated off through distilling the distillation is effected preferably at 50 to 90° C./0.01 to 0.2 bar.

Through tempering of the amino triazine ethers at 70 to 140° C. in the third step of the process in the process according to the invention for the production of amino resin moulding materials condensation is already initiated before dosing into the kneader.

Double worm extruders L/D=32-48 with opposing worm arrangement and several degassing zones are suitable as kneaders. For the purpose of separating off inhomogeneities the melt can be fed with a gear pump into a melt filter. The transformation of the melt into granulated particles can be effected in pastillising installations through dosing the melt by means of a feeding device onto a continuous steel belt and cooling and hardening of the deposited pastilles.

A preferred embodiment of the production of amino resin moulding materials consists in that in the third step of the process for further condensation of the amino triazine ethers to polytriazine ethers mixtures of products of the 2^{nd} step of the process which have been produced from various initial products or mixtures of products of the 2^{nd} step of the process with C₁-C₄-alkyl-oxa-C₁-C₈-alkylene-amino-substituted triazine derivatives which have not been re-etherified are used.

The proportion of the polytriazine ethers with the bridging members —NH—CHR₃—O—CHR₃—NH—/—NH—CHR₃—NH— is determined through the standing time in the extruder and the mass temperature in the extruder in the third step of the process. With short standing times and low mass temperatures in the extruder proportions of polytriazine ethers are still formed with the bridging members —NH—CHR₃—O—CHR₃—NH—. With longer standing times and higher mass temperatures in the extruder polytriazine ethers with bridging members —NH—CHR₃—O—CHR₃—NH— are no longer detectable.

Amino resin moulding materials wherein the polytriazine ethers are free of bridging members —NH—CHR₃—O—CHR₃—NH— are preferred.

As a preferred technological variant in the process for the production of amino resin moulding materials all the steps of the process can be performed one after the other in a reaction installation. Examples for suitable reaction installations for this technological variant are continuous kneaders, after which static kneaders can be arranged.

In the process according to the invention for the production of amino resin moulding materials, besides hard resins solutions of amino resin precondensates of triazine derivatives and C₁-C₈ aldehydes can also be used which have been produced directly in a previous step of the process through hydroxy alkylisation of triazine derivatives with C₁-C₈ aldehydes in C₁-C₄ alcohols or mixtures of 70 to 99 mass % C₁-C₄-alcohols and 30 to 1 mass % water, optionally in the presence of ionic catalysts, at 45 to 90° C. and with standing times of 15 to 140 min.

The particular advantage of the amino resin moulding materials according to the invention consists in that due to the higher melting viscosity in relation to the usual triazine derivative precondensates like melamine formaldehyde precondensates they can be processed like thermoresins according to melt processing methods and hardness and flexibility of the products thereby produced can be set within a broad range of properties.

The proportion of volatile fission products during the hardening of the amino resin moulding materials made from polytriazine ethers during the forming of the melt into the product is drastically reduced in relation to the usual moulds on the basis of low molecular amino resin precondensates.

Fissure-free products can thereby be produced from the amino resin moulding materials with short working times.

Preferred areas of use of the amino resin moulding materials are hot melt adhesives and the production of plates, pipes, profiles, injection moulded components, fibres and foams.

The amino resin moulding materials according to the invention, insofar as they do not contain any fillers or further reactive polymers, are soluble in polar solvents of the type C₁-C₁₀ alcohols, dimethyl formamide or dimethyl sulphoxide in concentrations up to 60 mass %. The solutions or dispersions are suitable as adhesive, impregnating agents, paint resin or laminating resin formulation or for the production of foams, mciro-capsules or fibres. The advantages of the solutions or dispersions of the polytriazine ethers in relation to the corresponding triazine resin precondensates consist in the higher viscosity and the thus resulting better levelling properties or higher strengths of non-hardened intermediate products in the production of fibre or foam.

The amino resin products are preferably semifinished products produced through melt processing, in particular plates, pipes, profiles, coatings, foams or fibres or forming substances, in particular injection moulded components, or components produced from fibres according to winding, braiding or pultrusion technology and subsequent resin impregnation.

In the amino resin moulding materials which form the basis of the amino resin products according to the invention as polytriazine ethers in the mixtures polytriazine ethers with R₂═H are preferred.

The mixtures of polytriazine ethers in the amino resin moulding materials can be mixtures of polytriazine ethers with the same or different substituent
R₁═—NH₂, —NH—CHR₂—O—R₃, —NH—CHR₂—O—R₄—OH, —OH, phthalimido-. succinimido- —NH—CHR₂—O—R₄—O—CHR₂—NH—, —NH—CHR₂—NH—, —NH—CHR₂—O—CHR₂—NH—

The fillers and adsorber materials contained in the amino resin products are preferably Al₂O₃, Al(OH)₃, SiO₂, barium sulphate, calcium carbonate, glass balls, silica, mica, quartz dust, slate dust, micro hollow spheres, carbon black, talc, layer silicates, molecular sieves, stone dust, wood flour, cellulose, cellulose derivatives. Particularly preferred as fillers are layer silicates of the type montmorillonite, bentonite, kaolinite, muscovite, hectorite, fluorohectorite, kanemite, revdite, grumantite, ilerite, saponite, beidelite, nontronite, stevensite, laponite, taneolite, vermiculite, halloysite, volkonskoite, magadite, rectorite, kenyaite, sauconite, boron fluorophlogopite and/or synthetic smectite. As an adsorber material layer silicates of the type montmorillonite, bentonite and hectorite, molecular sieves of the types A, X, Y, in particular 5A, adsorbers based on silicon, micro hollow spheres, cellulose and/or cellulose derivatives are particularly preferred.

Examples for reactive polymers of the type ethylene copolymers which can be contained in the amino resin products up to 50 mass % are part saponified ethylene vinyl acetate copolymers, ethylene butyl acrylate acrylic acid copolymers, ethylene hydroxyethyl acrylate copolymers or ethylene butyl acrylate glycidyl methacrylate copolymers.

Examples for reactive polymers of the type maelic acid anhydride copolymers which can be contained in the amino resin products up to 50 mass % are C₂-C₂₀-olefine-maleic acid anhydride copolymers or copolymers of maleic acid anhydride and C₈-C₂₀ vinyl aromates.

Examples for the C₂-C₂₀ olefine components which can be contained in the maleic acid anhydride copolymers are ethylene, propylene, butene-1, isobutene, diisobutene, hexene-1, octene-1, heptene-1, pentene-1, 3-methylbutene-1, 4-methylpentene-1, methylethylpentene-1, ethylpentene-1, ethylhexene-1, octadecene-1 and 5,6-dimethylnorbornene.

Examples for the C₈-C₂₀ vinyl aromate components which can be contained in the maleic acid anhydride copolymers are styrene, (α-methylstyrene, dimethylstyrene, isopropenylstyrene, p-methylstyrene and vinylbiphenyl.

The modified maleic acid anhydride copolymers optionally contained in the amino resin products are preferably partially or completely esterised, amidated or imidated maleic acid anhydride copolymers.

Particularly suitable are modified copolymers of maleic acid anhydride and C₂-C₂₀ olefines or C₈-C₂₀ vinyl aromates with a molar ratio of 1:1 to 1:9 and molar mass weight means of 5000 to 500000 which have been converted with ammonia, C₁-C₁₈ monoalkyl amines, C₆-C₁₈ aromatic monoamines, C₂-C₁₈ mono amino alcohols, monoaminated poly(C₂-C₄-alkylene)oxides of a molar mass of 400 to 3000, and/or mono-etherified poly(C₂-C₄-alkylene)oxides of a molar mass of 100 to 10000 wherein the molar ratio anhydride groups copolymers/ammonia, amino groups C₁-C₁₈ monoalkyl amines, C₆-C₁₈ aromatic monoamines, C₂-C₁₈ monoamino alcohols and monoaminated poly(C₂-C₄-alkylene)oxide and/or hydroxy groups poly(C₂-C₄-alkylene)oxide is 1:1 to 20:1.

Examples for reactive polymers of the type poly(meth)acrylates which can be contained in the amino resin products up to 50 mass % are copolymers based on functional unsaturated (meth)acrylate monomers like acrylic acid, hydroxyethyl acrylate, glycidyl acrylate, methacrylic acid, hydroxybutyl methacrylate, or glycidyl methacrylate and non-functional unsaturated (meth)acrylate monomers like ethyl acrylate, butyl acrylate, ethylhexyl acrylate, methyl methacrylate, ethyl acrylate and/or butyl methacrylate and/or C₈-C₂₀ vinyl aromates. Preferable are copolymers based on methacrylic acid, hydroxyethyl acrylate, methyl methacrylate and styrene.

Examples for reactive polymers of the type polyamides which can be contained in the amino resin products up to 50 mass % are polyamide-6, polyamide-6,6, polyamide-11, polyamid-12, polyamino amides of polycarbonic acids and polyalkylene amines and the corresponding methoxylated polyamides.

Examples for reactive polymers of the type polyesters which can be contained in the amino resin products up to 50 mass % are polyesters with molar masses of 2000 to 15000 of saturated dicarbonic acids like phthalic acid, isophthalic acid, adipic acid and/or Succinic acid, unsaturated dicarbonic acids like maleic acid, fumaric acid and/or itaconic acid and diols like ethylene glycol, butane diol, neopentyl glycol and/or hexane diol. Branched polyesters based on neopentyl glycol, trimethylol propane, isophthalic acid and azelaic acid are preferred.

Examples for reactive polymers of the type polyurethanes which can be contained in the amino resin products up to 50 mass % are untreated polyurethanes based on toluylene diisocyanate, diphenyl methane diisocyanate, butane diisocyanate and/or hexane diisocynate as diisocyanate components and butane diol, hexane diol and/or polyalkylene glycolne as diol components with molar masses of 2000 to 30000.

Up to 20 mass % diols of the type HO—R₄—OH can be contained in the amino resin products according to the invention.

Examples for diols of the type HO—R₄—OH, wherein R₄═C₂-C₁₈-alkylene, are ethylene glycol, butane diol, octane diol, dodecane diol and octadecane diol.

Examples for diols of the type HO—R₄—OH, wherein R₄═—[CH₂—CH₂—O—CH₂—CH₂]ₙ— and n=1-200, are polyethylene glycols with molar masses of 500 to 5000.

Examples for diols of the type HO—R₄—OH, wherein R₄═—[CH₂—CH(CH₃)—O—CH₂—CH(CH₃)]ₙ— and n=1-200, are polypropylene glycols with molar masses of 500 to 5000.

Examples for diols of the type HO—R₄—OH, wherein R₄═—[—O—CH₂—CH₂—CH₂—CH₂—]ₙ— and n=1-200, are polytetrahydrofuranes with molar masses of 500 to 5000.

Examples for diols of the type HO—R₄—OH, wherein R₄═—[(CH₂)₂₋₈—O—CO_{C6-C14}-arylene-CO—O—(CH₂)₂₋₈—]ₙ—, are esters and polyesters based on saturated dicarbonic acids like terephthalic acid, isophthalic acid or naphthaline dicarbonic acid and diols like ethylene glycol, butane diol, neopentyl glycol and/or hexane diol. Bis(hydroxyethyl)terephthalate is preferred as an ester.

Examples for diols of the type HO—R₄—OH, wherein R₄═—[(CH₂)₂₋₈—O—CO-_{C2-C12}-alkylene-CO—O—(CH₂)₂₋₈—]ₙ, are polyesters based on saturated dicarbonic acids like adipic acid and/or Succinic acid, unsaturated dicarbonic acids like maleic acid, fumaric acid, and/or itaconic acid and diols like ethylene glycol, butane diol, neopentyl glycol and/or hexane diol.

Examples for diols of the type HO—R₄—OH, wherein R₄=siloxane groups containing sequences of the type 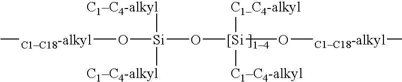
are 1,3-bis(hydroxybutyl)tetramethyl disiloxane and 1,3-bis(hydroxyoctyl)tetraethyl disiloxane.

Examples for polyester sequences with siloxane groups containing diols of the type HO—R₄—OH, wherein R₄═—[(X)ᵣ—O—CO—(Y)ₛ—CO—O—(X)ᵣ]—,
wherein
X═{(CH₂)₂₋₈—O—CO-_{C6-C14}-arylene-CO—O—(CH₂)₂₋₈−} or —{(CH₂)₂₋₈—O—CO-_{C2-C12}-alkylene-CO—O—(CH₂)₂₋₈—}; 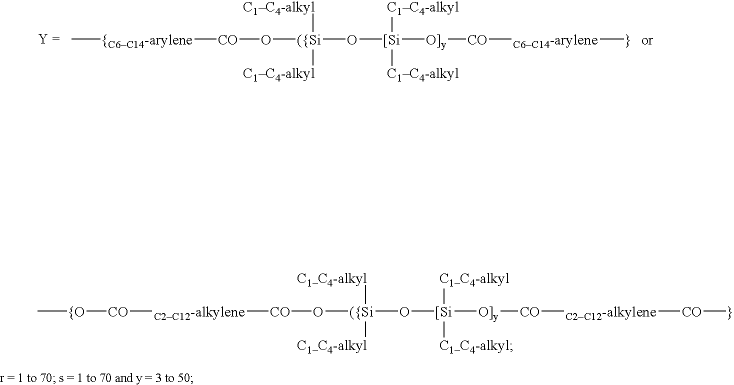
   are hydroxyl end group containing polyesters based on aromatic C₆-C₁₄-arylene dicarbonic acids like terephthalic acid or naphthaline dicarbonic acid, aliphatic C₂-C₁₂ alkylene dicarbonic acids like adipic acid, maleic acid or pimelic acid, diols like ethylene glycol, butane diol, neopentyl glycol or hexane diol and siloxanes like hexamethyl disiloxane or a,co-dihydroxypolydimethyl siloxane.

Examples for siloxane groups containing polyether diols HO—R₄—OH, wherein R₄ polyether sequences of the type 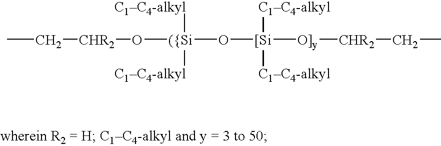
are polyether diols based on siloxanes like hexamethyl disiloxane or α,ω-dihydroxypolydimethyl siloxane and alkylene oxides like ethylene oxide or propylene oxide.

Examples for diols based on alkylene oxide adducts of melamine of the type 2-amino-4,6-bis(hydroxy-_{C2-C4}-alkylene-amino)-1,3,5-triazine are diols based on melamine and ethylene oxide or propylene oxide.

Examples for phenolic ether diols based on bivalent phenols and C₂-C₈ diols of the type bis(hydroxy-_{C2-C8}-alkylene-O—)_{C6-C8}-arylene are ethylene oxide adducts or propylene oxide adducts to diphenylol propane.

Examples for suitable stabilisers and UV absorbers which can be contained in the amino resin products up to 2 mass % are piperidine derivatives, benzophenone derivatives, benzotriazol derivatives, triazine derivatives and/or benzofuranone derivatives.

The amino resin products with improved flexibility are produced according to the invention according to a process wherein amino resin moulding materials which consist of mixtures of meltable 20 to 1000 nuclei polytriazine ethers,
wherein in the polytriazine ethers the triazine segments 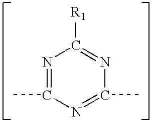
R₁═—NH₂, —NH—CHR₂—O—R₃, —NH—CHR₂—O—R₄—OH, —OH, phthalimido-. succinimido-, —NH—CHR₂—O—R₄—O—CHR₂—NH—, —NH—CHR₂—NH—, —NH—CHR₂—O—CHR₂—NH—,
R₂═H, C₁-C₇-alkyl;
R₃═C₁-C₁₈-alkyl, H;
R₄═C₂-C₁₈-alkylene, —CH(CH₃)—CH₂—O-_{C2-C12}-alkylene-O—CH₂—CH(CH₃)—, —CH(CH₃)—CH₂—O-_{C2-C12}-arylene-O—CH₂—CH(CH₃)—, —[CH₂—CH₂—O—CH₂—CH₂]ₙ—, —[CH₂—CH(CH₃)—O—CH₂—CH(CH₃)]ₙ—, —[—O—CH₂—CH₂—CH₂—CH₂—]ₙ—, —[(CH₂)₂₋₈—O—CO-_{C6-C14}-arylene-CO—O—(CH₂)₂₋₈—]ₙ—, —[(CH₂)₂₋₈—O—CO-_{C2-C12}alkylene-CO—O—(CH₂)₂₋₈—]ₙ—, wherein n=1 to 200;
   siloxane groups containing sequences of the type 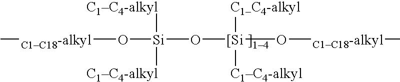
   siloxane groups containing polyester sequences of the type —[(X)ᵣ—O—CO—(Y)ₛ—CO—O—(X)ᵣ]—,
   wherein
   X═{(CH₂)₂₋₈—O—CO-_{C6-C14}-arylene-CO—O—(CH₂)₂₋₈—} or —{(CH₂)₂₋₈—O—CO-_{C2-C12}-alkylene-CO—O—(CH₂)₂₋₈—}; 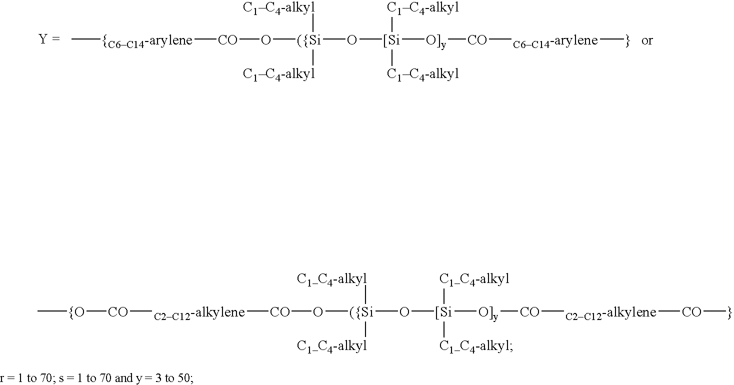
   siloxane groups containing polyether sequences of the type 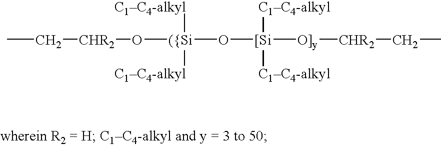
   sequences based on alkylene oxide adducts of melamine of the type 2-amino-4,6-di-_{C2-C4}-alkylene-amino-1,3,5-triazine sequences:
   phenolic ether sequences based on bivalent phenols and C₂-C₈ diols of the type -_{C2-C8}-alkylene-O-_{C6-C18}-arylene-O-_{C2-C8}-alkylene sequences;
      are combined through bridging members —NH—CHR₂—O—R₄—O—CHR₂—NH— und —NH—CHR₂—NH— and optionally —NH—CHR₂—O—CHR₂—NH— to 20 to 1000 nuclei polytriazine ethers with linear and/or branched structure,
wherein in the polytriazine ethers the molar ratio of the substituents is R₃:R₄=20:1 to 1:20,
the proportion of the combinations of the triazine segments through bridging members —NH—CHR₃—O—R₄—O—CHR₃—NH— is 5 to 95 mol %,
and wherein the amino resin moulding materials can contain up to 75 mass % fillers and/or adsorber materials, up to 50 mass % further reactive polymers of the type ethylene copolymers, maleic acid anhydride copolymers, modified maleic acid anhydride copolymers, poly(meth)acrylates, polyamides, polyesters and/or polyurethanes, up to 20 mass % diols of the type HO—R₄—OH and up to 5 mass % stabilisers, UV absorbers, hardening agents and/or auxiliary substances,
   are melted in continuous kneaders at mass temperatures of 105 to 260° C. and standing times of 2 to 12 min and with hardening of the polytriazine ethers according to the usual processing methods for thermoresin polymers.

A) placed as a melt on a smoothing device and taken out as a plate by means of conveyor belts and cut or sealed on surface guides made from metallised films, synthetic films, paper guides or textile guides and removed and manufactured as multicomponent composites, or

B) taken out via a profiled opening and removed, cut and manufactured as a profile or plate material, or

C) taken out via an annular opening, removed with pressing of air as a pipe, cut and manufactured, or

D) after dosing of blowing agents removed taken out via a wide slot opening and removed as a foamed plate material, or

E) taken out via the wide slot opening of a pipe coating installation and sealed in a fusible manner onto the rotating pipe, or

F) processed into injection moulded components in injection moulding machines, preferably with three zone worms with a worm length of 18 to 24 D, high injection speeds and with tool temperatures of 70 to 150° C., or

G) extruded in melt spinning installations by means of melt pump through the capillary tool into the blow shaft and taken out as threads or after the melt-blow process separated off as fibres or after the rotation spinning process taken out as a melt into a shear field chamber with organic dispersing agents with the formation of fibre fibrides and further processed in subsequent devices, or

K) used for the melt impregnation of component blanks produced according to the winding process, braiding process or pultrusion process,

and the products are optionally subjected, for the purpose of complete hardening, to subsequent thermal processing at temperatures of 180 to 280° C. and standing times of 20 to 120 min.

The amino resin moulding materials used in the process for producing amino resin products can be used in the form of cylindrical, lens-shaped, pastille-shaped or spherical particles with an average diameter of 0.5 to 8 mm.

The mixtures of meltable 20 to 1000 nuclei polytriazine ethers contained in the amino resin moulding materials can be produced through etherification of methylolated amino triazines with C₁-C₄ alcohols, partial re-etherification of the amino triazine ethers with diols of the type H—O—R₄—H and/or partial conversion with bisepoxides of the type 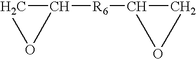
wherein
R₄═C₂-C₁₈-alkylene, —[CH₂—CH₂—O—CH₂—CH₂]ₙ—, —[CH₂—CH(CH₃)—O—CH₂—CH(CH₃)]ₙ—, —[—O—CH₂—CH₂—CH₂—CH₂—]ₙ——[(CH₂)₂₋₈—O—CO-_{C6-C12}-aryl-CO—O—(CH₂)₂₋₈—]ₙ—, —[(CH₂)₂₋₈—O—CO-_{C6-C12}-alkylene-CO—O—(CH₂)₂₋₈—]ₙ—, n=1 to 200, siloxane groups containing polyester sequences or polyether sequences, sequences based on alkylene oxide adducts of melamine, phenolic ether sequences based on bivalent phenols and diols,
and R₆═—CH₂—O-_{C2-C12}-alkylene-O—CH₂—, —CH₂—O-_{C6-C14}-arylene—O—CH₂—,
and subsequent melt mixing of the amino triazine ethers. Besides diols trivalent and/or tetravalent alcohols can also be used as polyvalent alcohols.

In the production of the amino resin products according to the invention amino resin moulding materials are preferably used wherein the polytriazine ethers contained therein are 30 to 300 nuclei polytriazine ethers.

It is particularly advantageous in the production of amino resin products with improved flexibility to use amino resin moulding materials wherein the polytriazine ethers contained therein are polytriazine ethers with R₂═H.

Preferably the hardening agents contained in the amino resin moulding materials used in the production of the amino resin products according to the invention are preferably weak acids of the type
blocked sulphonic acids,
aliphatic C₄-C₁₈ carbon acids,
alkali salts or ammonium salts of phosphoric acid,
C₁-C₁₂ alkyl ester or C₂-C₈ hydroxyalkyl ester of C₆-C₁₄ aromatic carbonic acids or anorganic acids,
salts of melamine or guanamines with C₁-₁₈ aliphatic carbonic acids,
anhydrides, semi-esters or semi-amides of C₄-C₂₀ dicarbonic acids,
semi-esters or semi-amides of copolymers of ethylenically unsaturated C₄-C₂₀-dicarbonic acid anhydrides and ethylenically unsaturated monomers of the type C₂-C₂₀ olefines and/or C₈-C₂₀ vinyl aromates, and/or
salts of C₁-C₁₂ alkyl amines or alkanol amines with C₁-C₁₈ aliphatic, C₆-C₁₄ aromatic or alkyl aromatic carbonic acids and anorganic acids of the type hydrochloric acid, sulphuric acid or phosphoric acid.

The weak acids contained as hardening agents in the amino resin moulding materials used can be added during the formulation of the amino resin moulding materials and/or after the melting of the amino resin moulding materials before the forming into semifinished product or forming substance.

Examples for blocked sulphonic acids as hardening agents in the production of the amino resin products according to the invention are benzilmonoxime-tosylat, (α-cyclohexylsulphonyl-oxyimino-phenyl acetic acid ethyl esters, acetonoxim-p-benzoylbenzol sulphonate, α-(4-nitro-benzol-sulphonyloxyimino)benzylcyanide, 2-nitrobenzylsulfonate und 2-methylsulfonyloxyimino-4-phenyl-but-3-ennitril.

Examples for aliphatic C₄-C₁₈ carbonic acids as hardening agents in the production of the amino resin products according to the invention are butyric acid, capronic acid, palmitic acid, stearic acid and oleic acid.

Examples for alkali salts or ammonium salts of phosphoric acid as hardening agents which are contained in the amino resin moulding materials used in the production of the amino resin products according to the invention are ammonium hydrogen phosphate, sodium polyphosphate and potassium hydrogen phosphate.

Examples for C₁-C₁₂ alkyl esters or C₂-C₈ hydroxy alkyl esters of C₆-C₁₄ aromatic carbonic acids or anorganic acids as hardening agents in the production of the amino resin products according to the invention are dibutyl phthalate, phthalic acid diglycol esters and/or trimellith acid glycol esters.

Examples for salts of melamine or guanamines with C₁-₁₈ aliphatic carbonic acids as hardening agents in the production of the amino resin products according to the invention are melamine formiate, melamine citrate and/or acetoguanamine butyrate.

Examples for anhydrides, semi-esters or semi-amides of C₄-C₂₀ dicarbonic acids as hardening agents in the production of the amino resin products according to the invention are maleic acid anhydride, mono-C₁-C₁₈ alkyl maleates like maleic acid monobutyl esters, maleic acid monoethylhexyl esters or monostearyl maleate or maleic acid mono-C₁-C₁₈-alkyl amides like maleic acid monoethyl amide, maleic acid monooctyl amide or maleic acid monostearyl amide.

Examples for semi-esters or semi-amides of copolymers of ethylenically unsaturated C₄-C₂₀ dicarbonic acid anhydrides and ethylenically unsaturated monomers of the type C₂-C₂₀ olefines and/or C₈-C₂₀ vinyl aromates as hardening agents in the production of the amino resin products according to the invention are semi-esters or semi-amides of copolymers of maleic acid anhydride and C₃-C₈-α olefines of the type isobutene, diisobutene and/or 4-methylpentene and/or styrene with a molar ratio maleic acid anhydride/C₃-C₈-α-olefine or styrene or corresponding monomer mixtures of 1:1 to 1:5.

Examples for salts of C₁-C₁₂ alkyl amines or alkanol amines with C₁-C₁₈-aliphatic, C₆-C₁₄ aromatic or alkyl aromatic carbonic acids and anorganic acids of the type hydrochloric acid, sulphuric acid or phosphoric acid as a hardening agent in the production of the amino resin products according to the invention are ethanol ammonium chloride, triethyl ammonium maleate, diethanol ammonium phosphate and/or isopropyl ammonium-p-toluol sulphonate.

Examples for suitable auxiliary substances which can be used in the process according to the invention for the production of amino resin products are auxiliary processing means such as calcium stearate, magnesium stearate and/or wax.

For the production of amino resin products which contain fillers, adsorber materials, further reactive polymers, diols, stabilisers, UV absorbers and/or auxiliary substances moulds can be used, in which these components are already contained, or the components are added during the processing of the amino resin moulding materials into amino resin products.

For the melting of the amino resin moulding materials during the production of the amino resin products extruders with short compression worms or three zone worms with L/D=20-40 are suitable as continuous kneaders. 5 zone worms with entry zone, compression zone, shearing zone, decompression zone and homogenisation zone are preferable. Worms with cutting depths of 1:2.5 to 1:3.5 are preferably suitable. The intermediate arrangement of static kneaders or melt pumps between cylinder and opening is particularly favourable.

Favourable mass temperatures for the melted amino resin moulding materials during the processing according to smoothing device technology into amino resin products in the form of plates or coatings or during the production of plates, profiles or pipes through removal through a profiled opening lie in the range of 140 to 220° C.

During the production of foamed plate material as an amino resin product through removal via a wide slot opening amino resin moulding materials can be used which contain gas separating blowing agents like sodium bicarbonate, azodicarbonamide, citric acid/bicarbonate blowing systems and/or cyanur acid trihydrazide, or before removal slightly volatile hydrocarbons like pentane, isopentane, propane and/or isobutane, or gases like nitrogen, argon and/or carbon dioxide are dosed into the melt. Favourable opening temperatures for the removal of the melt containg blowing agents are 135 to 185° C. Preferred foam densities of the foamed amino resin products lie in the range of 10 to 500 kg/m².

For the extrusion coating of metal pipes mass temperatures of the melts of amino resin moulding materials of 145° C. to 210° C. and preheating of the pipe material to 120 to 160° C. are necessary.

In the production of amino resin injection moulded products injection moulding machines are preferably used with injection units which have three zone worms with a worm length of 18 to 24 D. The injection speed in the production of the moulding products produced through injection moulding should be set as high as possible in order to exclude shrink marks and poor binding seams. Preferred melt temperatures lie in the region of 170 to 260° C.

In the production of fibre products from amino resins, for the purpose of regular melt dosing of the moulds melted in the resinisation extruder via the melt distributor to the capillary tool diphenyl heated melt pumps are preferably used for the melts heated to 170-250° C.

The production of filament yarns as amino resin products can be effected in short spinning installations through the removal of the threads with the aid of fast running “galeften” with thread removal speeds at 60 to 450 m/min and further processing in subsequent devices composed of a hardening chamber, stretching device and winder.

Fibres or fleeces as amino resin products can likewise be produced according to the melt-blow process through application of a greatly heated air flow around the capillary outlet openings during the extrusion of the threads from the capillary tool into the blow shaft. The air flow stretches the melted thread with simultaneous division into many small individual fibres with fibre diameters of 0.5 to 2 μm. Further processing of the fibres deposited on the sieve conveyor belt into fleeces can be effected through application of thermobonding or needling processes in order to achieve the required strength and dimension stability.

In the process for the production of amino resin products according to the invention the production of fibre fibrides from the amino resin moulding materials is preferably effected by
introducing the melt via entry openings at melt temperatures of 160 to 220° C. into a shear field chamber which contains high boiling organic dispersion agent heated to 150 to 210° C., preferably paraffin oil or engine oil, wherein acid gases, preferably chlorohydrogen or sulphur dioxide are introduced into the shear field chamber, and wherein the melt stream leaving the entry opening is extended and divided through the oil whirled about by the rotor with the formation of fibres,
conveyance of the dispersion of the fibre fibrides formed in organic dispersion agent into a sieve separator with simultaneous extraction of the high boiling dispersion agent with low boiling hydrocarbons, preferably hexane or heptane,
removal of the fibre fibride short fibre fleece and optionally subsequent thermal treating of the short fibre fleece at temperatures of 190 to 240° C. and standing times of 40 to 120 min.

Amino resin products in the form of rotation symmetrical components according to the winding process, in the form of complex components according to round braiding technology or profiles according to pultrusion technology can be produced through impregnation of the fibre blanks in the form of pipes, fittings, containers or profiles with the melt of the amino resin mould.

The hardness and flexibility of the products produced is determined by the content of the bridging members between the triazine segments, type and molar mass of the substituent R₄ in the bridging members, the proportion of linear combinations between the triazine segments and furthermore by the proportion of longer chain substituents to the triazine segments which result from the conversion with C₅-C₁₈ alcohols. The higher the proportion and the molar mass of the bridging members, the proportion of the linear triazine segment combinations and the proportion of longer chain substituents the greater is the flexibility of the amino resin products produced.

The amino resin products with improved flexibility are preferably used for applications with high requirements of non-flammability and heat resistance in construction, engineering and the motor car industry, in particular in the form of foam plates as isolation components, in the form of plates as panelling elements, in the form of pipes and hollow profiles in ventilation technology, in the form of injection moulded components as functional components and in the form of fibres in particular for the production of electro-isolation papers, fire protection clothing, clothing for high working temperatures, fire protection blankets, filter fleeces, felts for paper machines and vehicle or machine isolation covers, and in the form of complex components, containers or profiles according to the winding, braiding or pultrusion process.

The invention is clarified through the following examples:

### EXAMPLE 1

1.1 Production of the Etherified Amino Triazine Aldehyde Precondensate

For the production of the precondensate, 5.05 kg melamine, 4.2 kg paraformaidehyde, 21 g p-toluol sulphonic acid and 17.9 kg methanol are dosed into a 50 l agitation reactor. Within 15 min it is heated to 90° C. and further agitated at this temperature until a clear solution is obtained. After cooling to room temperature it is set with 20% methanolic KOH to a pH of 8.7. Subsequently the solution is brought down in a two-step vaporisation stage to a remaining solution average content of 10 mass %.

1.2 Production of the Amino Resin Mould

For the production of the amino resin mould, 2,4,6-tris-methoxymethylamino-1,3,5-triazine according to 1.1 is used as an etherified precondensate and bis(hydroxyethyl)terephthalate as a diol component.

The re-etherification and further condensation to the polytriazine ether is performed discontinuously in the measurement kneader (Haake Polylabsystem 540 p). After preheating to 170° C., 32.5 g bis(hydroxyethyl)terephthalate and 39.5 g 2,4,6-tris-methoxymethylamino-1,3,5-triazine are dosed into the mixing chamber and mixed at a speed of 50 min⁻¹ until a torque of 3 Nm is reached after a reaction time of 6 min. The methanol released during the compounding is removed from the mixing chamber through vacuum. The polytriazine ether is removed after cooling and milled in a universal mill 100 UPZ/II (Alpine Hosokawa) with impact disc and 2 mm sieve.

The content of unconverted bis(hydroxyethyl)terephthalate ascertained in the reaction product through HPLC is 19 mass %. The viscosity of the amino resin mould at 140° C. is 300 Pa·s.

1.3 Production of Prepregs and 3 D Profile Laminates

The production of the prepregs is effected by means of powdering of cellulose fleeces (120g/m², Lenzing AG, Austria) with the finely milled polytriazine ether according to 1.2 (average particle diameter 0.1 mm) with subsequent melting of the powder in the infrared radiation field at about 150° C. The thus produced prepregs have a resin deposit of approx. 50%.

The prepregs are cut to a size of 30×20 cm. For the purpose of producing a forming component with bent edges in the sense of a U profile, 3 prepegs plus an untreated cellulose fleece as an upper side are placed over each other into a compression mould (30×20 cm) preheated to 150° C. and the press is slowly closed wherein the prepregs can be easily shaped due to the not yet hardened resin. Under a pressure of 150 bars the temperature is increased to 180° C. and pressing takes place for 15 min. The finished workpiece is removed, slowly cooled and the burr which has formed on the immersion edge of the compression moulding tool through the resin leaving is ground off.

Sample bodies milled from the workpiece have in the bending test an E module of 5.6 GPa, a strain at maximum force of 3.2% and an impact strength of 12.5 kJ/m².

### EXAMPLE 2

For the production of the polytriazine ether a mixture of 75 mass % 2,4,6-tris-ethoxymethylamino-1,3,5-triazine and 25 mass % of a triazine methyl ether which has been produced from a precondensate of butyroguanamine/melamine 1:5 as an amino triazine component and butyral dehyde/formaldehyde 1:8 as an aldehyde component with an aldehyde/amino triazine ratio 3:1 is used as an etherified precondensate. The diol component forms a mixture of 50 mass % butane diol and 50 mass % of a polypropylene glycol with a molar mass of 500.

The re-etherification and further condensation to the polytriazine ether is performed discontinuously in the measuring kneader (Haake Polylabsystem 540 p). After preheating to 175° C., 45 g of the triazine ether mixture and 35 g of the mixture of the diol components are dosed into the mixing chamber and mixed at a speed of 50 min⁻¹ for 12 min. The alcohol mixture released during the compounding is removed from the mixing chamber by vacuum. After 10 min, 5 mass % namontmorillonite (Südchemie AG) and 5 mass %, each in relation to the amino triazine mixture, polyamid D1466 (Ems-Chemie) are added and mixed for a further 5 min. The amino resin mould is removed after cooling and milled in a universal mill 100 UPZ/II (Alpine Hosokawa) with impact disc and 2 mm sieve.

### EXAMPLE 3

For the production of the polytriazine ether, a mixture of 20 mass % 2,4-bis-methoxymethylamino-6-methyl-1,3,5-triazine and 80 mass % 2,4,6-tris-methoxymethylamino-1,3,5-triazine as an etherified precondensate and an oligoethylene glycol ether based on pentaerythrite (Simulsol PTKE, Seppic S.A., Frankreich) as a diol are used.

In a laboratory extruder GL 27 D44 (Leistritz) with vacuum degassing, temperature profile 130°0 C./150° C./190° C./230° C./230° C./230° C./230° C./230° C./230° C./100° C./100° C. the mixture of the etherified precondensate is gravimetrically dosed into the entry funnel at 1.38 kg/h and by means of side flow dosing into the entry zone the diol based on pentaerythrite 1.12 kg/h is gravimetrically dosed. By means of side flow dosing at 0.1 kg/h a sodium montmorillonite (Sudchemie, Moosburg Deutschland) treated on the surface with Succinic acid is dosed into zone 8 of the extruder. The extrusion is effected with an average standing time of 3 to 4 min. The extruder speed is 150 min⁻¹. The stream of the filled polytriazine ether leaving the extruder is cut in a granulator.

The amino resin mould is characterised by a low viscosity at 150° C. of about 100-200 Pas.

### EXAMPLES 4 TO 15

Test performance as in Example 1.2. As diols simulsol BPLE (oligoethylene glycol ether of bisphenol A, Seppic S.A., Paris), simulsol PTKE (oligoethylene glycol ether of pentaerythrite, Seppic S.A., Paris), PEG 1000 (polyethylene glycol, molar mass about 1000, BASF), 1,6 hexane diol, 1,12 dodecane diol, PTHF 250 (polytetrahydrofurane molar mass 250, BASF Schwarzheide) and 1,3-bis(hydroxybutyl)tetramethyl disiloxane are used

| | | | | | Viscosity | Remaining |
|---|---|---|---|---|---|---|
| | | Mass | | | [Pa s]/140° C. | diol content |
| | | % in | Temp | Reaction time | (DMA- | (HPLC) |
| E.g. No. | Diol | mixture | [° C.] | [min] up to 3 Nm | values) | [Weight %] |
| 4 | simulsol BPLE | 24.1 | 170 | 14 | 300 | 15% |
| 5 | simulsol BPLE | 24.1 | 200 | ˜5-7 | 800 | 14% |
| 6 | simulsol | 24.1 | 170 | 13 | 700 | 15% |
| | PTKE | | | | | |
| 7 | simulsol | 24.1 | 200 | ˜6-8 | 1000 | 12% |
| | PTKE | | | | | |
| 8 | PEG 1000 | 39.4 | 170 | 15 | 1200 | 20% |
| 9 | PEG 1000 | 39.4 | 200 | ˜6-7 | 1400 | 17% |
| 10 | 1,6-hexane | 21.1 | 170 | 17 | 1000 | 10% |
| | diol | | | | | |
| 11 | 1,6-hexane | 7.1 | 170 | 14 | 400 | 4% |
| | diol | | | | | |
| 12 | 1,12- | 29.1 | 130*⁾ | ˜30 | 400 | 15% |
| | dodecane diol | | | | | |
| 13 | 1,12- | 29.1 | 120*⁾ | ˜40 | 800 | 12% |
| | dodecane diol | | | | | |
| 14 | PTHF 250 | 32.8 | 120*⁾ | ˜40 | 1200 | 20% |
| 15 | 1,3- | 29.5 | 170 | ˜11 | 300 | 17% |
| | bis(hydroxybutyl) | | | | | |
| | tetramethyl | | | | | |
| | disiloxane | | | | | |

*⁾In the examples 12 to 14, 0.1 mass %, in relation to the sum of the mixture components, p-toluol sulphonic acid as an auxiliary substance was added.

During the re-esterisation and condensation in the kneader, 38 to 59 mass % of the diol used is bound to the polytriazine ether.

The polytriazine ether in Example 5 provides in the molar mass determination (GPC) Mₙ=1800 and M_{w}=22700. The remaining —OCH₃ content (GC) of the polytriazine ether is 14.5 mass %, the viscosity at 140° C. 800 Pa·s

### EXAMPLE 16

For the production of the polytriazine ether, 2,4,6-tris-methoxymethylamino-1,3,5-triazine according to Example 1 is used as an etherified precondensate and the ethylene glycol diether of bisphenol A (simulsol BPLE, Seppic S.A., Frankreich) is used as a diol.

The re-etherification and further condensation to the polytriazine ether is effected at 200° C. in the laboratory extruder GL 27 D44 with vacuum degassing (Leistritz) with a temperature profile of 100° C./130° C./130° C./200° C./200° C./200° C./200° C./200° C./200° C./100° C./100° C. and an average standing time of 2 to 3 min. The extruder speed is 150 min⁻¹. 2,4,6-tris-methoxymethylamino-1,3,5-triazine is gravimetrically dosed into the entry zone of the extruder at 1.38 kg/h and the ethylene glycol diether of bisphenol A at 1.13 kg/h by means of side flow dosing. The stream of the polytriazine ether leaving the extruder is cut in a granulator. The resulting amino resin mould has a viscosity at 140° C. of 250 Pa·s and a content of untreated diol ascertained through HPLC of 15 mass %.

### EXAMPLES 17 TO 30

Test performance like Example 16. As diols, DGT (bis(hydroxyethyl)tere-phthalate), simulsol BPLE (oligoethylene glycol ether of bisphenol A, Seppic S.A., Paris), simulsol PTKE (oligo ethylene glycol ether of pentaerythrite, Seppic S.A., Paris), PEG 1000 (polyethylene glycol, molar mass about 1000, BASF), 1,6 hexane diol, 1,12 dodecane diol, PTHF 250 (polytetrahydrofurane molar mass 250, BASF Schwarzheide) and 1,3-bis(hydroxybutyl)tetramethyl disiloxane are used.

The temperatures in the cylinder sections during the re-esterisation and condensation in the Leistritz extruder were:

| | | | | | | | | | | |
|---|---|---|---|---|---|---|---|---|---|---|
| 1^{st} | 2^{nd} | 3^{rd} | 4^{th} | 5^{th} | 6^{th} | 7^{th} | 8^{th} | 9^{th} | 10^{th} | |
| cyl. | cyl. | cyl. | cyl. | cyl. | cyl. | cyl. | cyl. | cyl. | cyl. | Outlet |

Example 17

| | | | | | | | | | | |
|---|---|---|---|---|---|---|---|---|---|---|
| 100° C. | 130° C. | 130° C. | 200° C. | 200° C. | 200° C. | 200° C. | 200° C. | 200° C. | 100° C. | 100° C. |

Examples 18 to 20

| | | | | | | | | | | |
|---|---|---|---|---|---|---|---|---|---|---|
| 130° C. | 150° C. | 190° C. | 230° C. | 230° C. | 230° C. | 230° C. | 230° C. | 230° C. | 100° C. | 100° C. |

Examples 21 and 22

| | | | | | | | | | | |
|---|---|---|---|---|---|---|---|---|---|---|
| 130° C. | 150° C. | 190° C. | 230° C. | 230° C. | 230° C. | 230° C. | 230° C. | 230° C. | 100° C. | 100° C. |

Examples 23 and 24

| | | | | | | | | | | |
|---|---|---|---|---|---|---|---|---|---|---|
| 130° C. | 150° C. | 190° C. | 240° C. | 240° C. | 240° C. | 240° C. | 240° C. | 240° C. | 100° C. | 100° C. |

Examples 25 and 26

| | | | | | | | | | | |
|---|---|---|---|---|---|---|---|---|---|---|
| 100° C. | 110° C. | 130° C. | 150° C. | 170° C. | 170° C. | 170° C. | 170° C. | 170° C. | 100° C. | 100° C. |

Examples 27 and 28

| | | | | | | | | | | |
|---|---|---|---|---|---|---|---|---|---|---|
| 100° C. | 120° C. | 150° C. | 170° C. | 190° C. | 190° C. | 190° C. | 190° C. | 190° C. | 100° C. | 100° C. |

Example 29

| | | | | | | | | | | |
|---|---|---|---|---|---|---|---|---|---|---|
| 100° C. | 130° C. | 160° C. | 180° C. | 200° C. | 200° C. | 200° C. | 200° C. | 200° C. | 100° C. | 100° C. |

Example 30

| | | | | | | | | | | |
|---|---|---|---|---|---|---|---|---|---|---|
| 100° C. | 120° C. | 130° C. | 160° C. | 160° C. | 160° C. | 160° C. | 160° C. | 160° C. | 100° C. | 100° C. |

| | | Triazine | | | | | Remaining |
|---|---|---|---|---|---|---|---|
| | | ether | Diol | | | | diol content |
| | | mass % | mass % | Mass | | Viscosity | in mixture |
| E.g. | | in | in | throughput | Speed | [Pa s]/ | (HPLC) |
| No. | Diol | mixture | mixture | [kg/h] | [min⁻¹] | 140° C. | mass % |
| 17 | DGT | 54.8 | 45.2 | 5 | 250 | 200 | 18% |
| 18 | simulsol BPLE | 48.6 | 51.4 | 2.5 | 150 | 1000 | 20% |
| 19 | simulsol BPLE | 75.9 | 24.1 | 5 | 250 | 500 | 12% |
| 20 | simulsol BPLE | 75.9 | 24.1 | 2.5 | 150 | 700 | 10% |
| 21 | simulsol PTKE | 75.9 | 24.1 | 5 | 250 | 800 | 8% |
| 22 | simulsol PTKE | 75.9 | 24.1 | 2.5 | 150 | 1000 | 6% |
| 23 | PEG 1000 | 60.6 | 39.4 | 5 | 250 | 900 | 16% |
| 24 | PEG 1000 | 60.6 | 39.4 | 2.5 | 150 | 1100 | 14% |
| 25 | 1,6-hexane diol | 78.9 | 21.1 | 5 | 250 | 700 | 13% |
| 26 | 1,6-hexane diol | 92.9 | 7.1 | 2.5 | 150 | 800 | 3% |
| 27 | 1,12-dodecane | 70.9 | 29.1 | 2.5 | 150 | 900 | 12% |
| | diol | | | | | | |
| 28 | 1,12-dodecane | 70.9 | 29.1 | 5 | 250 | 600 | 14% |
| | diol | | | | | | |
| 29 | PTHF 250 | 67.2 | 32.8 | 5 | 250 | 1200 | 17% |
| 30 | 1.3-bis(hydroxybutyl) | 70.5 | 29.5 | 2.5 | 150 | 700 | 13% |
| | tetramethyl | | | | | | |
| | disiloxane | | | | | | |

During the re-esterification and condensation in the extruder, 38 to 67 mass % of the diol used is bound to the polytriazine ether.

The polytriazine ether in Example 17 provides with the molar mass determination (GPC) Mₙ=1600 and M_{w}=18500. The remaining —OCH₃— content (GC) of the polytriazine ether is 14.3 mass %, the viscosity at 140° C. 200 Pa·s.

The polytriazine ether in Example 23 produces with the molar mass determination (GPC) Mₙ=2900 and M_{w}=145000. The remaining —OCH₃— content (GC) of the polytriazine ether is 11.2 mass %, the viscosity at 140° C. 900 Pa·s .

### EXAMPLE 31

For the production of the amino resin mould a precondensate with 2,4,6-tris-methoxymethylamino-1,3,5-triazine is used as a main component (content of —NH—CH₂— groups 1.56 mol/mol triazine, content of —OCH₃— groups 1.95 mol/mol triazine) and bisphenol-A-diglycide ether (molar mass 340) is used as a bisepoxy compound.

The conversion with the bisepoxy compound and further condensation to the polytriazine ether is performed discontinuously in the measuring kneader (Haake Polylabsystem 540 p). After preheating to 170° C., 59 g of the precondensate with -2,4,6-tris-methoxymethylamino-1,3,5-triazine as a main component is dosed into the mixing chamber and after melting of the precondensate, 13 g bisphenol-A-diglycide ether is added (ratio —NH—CH₂— groups triazine ether/epoxy groups bisepoxy compound=5:1) and mixed at a speed of 30 min⁻¹ until a torque of 3 Nm is reached. The methanol released during the compounding is removed from the mixing chamber by vacuum. The polytriazine ether is removed after cooling and milled in a universal mill 100 UPZ/II (Alpine Hosokawa) with impact disc and 2 mm sieve.

The viscosity of the amino resin mould at 140° C. is 420 Pa·s.

### EXAMPLE 32

### Production of Composite Resins

32.1 Production of the Mould from Polytriazine Ethers

For the production of the polytriazine ether, 2,4,6-tris-methoxymethylamino-1,3,5-triazine is used as an etherified melamine formaldehyde precondensate and the ethylene glycol diether of bisphenol A (simulsol BPLE, Seppic S.A., Frankreich) is used as a diol.

The re-etherification and further condensation to the polytriazine ether is effected at 200° C. in the laboratory extruder GL 27 D44 with vacuum degassing (Leistritz) with a temperature profile of 100° C./130° C./130° C./200° C./200° C./200° C./200° C./200° C./200° C./100° C./100° C. and an average standing time of 2 to 3 min. The extruder speed is 150 min⁻¹.2,4,6-tris-methoxymethylamino-1,3,5-triazine is gravimetrically dosed by means of side flow dosing into the entry zone of the extruder at 1.38 kg/h and the ethylene glycol diether of bisphenol A at 1.13 kg/h. The stream of the polytriazine ether leaving the extruder is cut in a granulator.

The molar mass of the polytriazine ether ascertained through GPC is 1800. The content of unconverted simulsol BPLE according to HPLC analysis (solution in THF, UV detection with external standard) is 14 mass %. The proportion of the —OCH₃— groups in the polytriazine ether (ascertained through GC analysis after fission of the polytriazine ether with mineral acid) is 14.5 mass %. The viscosity at 140° C. is 800 Pa·s.

32.2 Production of Prepregs and 3D profile laminates

The production of prepregs is effected by means of powdering of cellulose fleeces (120 g/m², Lenzing AG, Austria) with the finely milled polytriazine ether according to 1.1 (average particle diameter 0.1 mm) with subsequent melting of the powder in the infrared radiation field at about 150° C. The thus produced prepregs have a resin deposit of about 50%.

The prepregs are cut to a size of 30×20 cm. For the purpose of producing a forming component with bent edges in the sense of a U profile, 3 prepregs plus an untreated cellulose fleece as an upper side are placed over each other into a compression mould (30×20 cm) preheated to 150° C. and the press is slowly closed wherein the prepregs can be easily shaped due to the not yet hardened resin. Under a pressure of 150 bars the temperature is increased to 180° C. and pressing is effected for 15 min. The finished workpiece is removed, slowly cooled and the burr formed on the immersion edge of the compression moulding tool through the resin leaving is ground off.

Sample bodies milled from the workpiece have in the bending test an E module of 5.6 GPa, a strain at maximum force of 3.2% and an impact strength of 12.5 kJ/m².

The remaining content of free simulsol BPLE in the workpiece (8 hours extraction of milled samples with dioxane, HPLC analysis) is 0.3 mass %. The proportion of the —OCH₃— groups in the treated polytriazine ether (ascertained through GC analysis after fission of the polytriazine ether with mineral acid) is 2.7 mass %.

### EXAMPLE 33

### Production of Amino Resin Glass Fibre Composites

33.1 Production of the Amino Resin Mould

For the production of the polytriazine ether, 2,4,6-Tris-methoxymethylamino-1,3,5-triazine is used as an etherified melamine formaldehyde precondensate and bis(hydroxyethyl)terephthalate is used as a diol.

The re-etherification and further condensation to the polytriazine ether is performed discontinuously in the measuring kneader (Haake Polylabsystem 540 p). After preheating to 170° C., 32.5 g bis(hydroxyethyl)terephthalate and 39.5 g 2,4,6-tris-methoxymethylamino-1,3,5-triazine are dosed into the mixing chamber and mixed at a speed of 50 min⁻¹ for 10 min. The methanol released during the compounding is removed from the mixing chamber by vacuum. After 10 min., 5 mass % Na-montmorillonite (Sudchemie AG) and 5 mass %, each in relation to 2,4,6-tris-methoxymethylamino-1,3,5-triazine, polyamide D1466 (Ems-Chemie) are added and mixed for a further 5 min. The polytriazine ether is removed after cooling and milled in a universal mill 100 UPZ/II (Alpine Hosokawa) with impact disc and 2 mm sieve.

The molar mass of the polytriazine ether ascertained through GPC is 1600. The content of unconverted bis(hydroxyethyl)terephthalate according to HPLC analysis (solution in THF, UV detection with external standard) is 18 mass %. The proportion of the —OCH₃— groups in the polytriazine ether (ascertained through GC analysis after fission of the polytriazine ether with mineral acid) is 14.3 mass %. The viscosity at 140° C. is 200 Pa·s.

33.2 Production of Plates Reinforced with Endless Glass Fibres

For the production of amino resin plates reinforced with endless glass fibre, 10 deposits of the granulate produced in 2.1 is melted in the laboratory extruder at 190° C. and by means of a wide slot opening is continuously fed to a glass fibre fleece (105 g/m²) moved at 0.8 m/min. Through the impregnation the surface mass of the glass fibre fleece is increased to 165 g/m². The impregnated glass fibre fleece is continuously fed, together with two further glass fibre fleeces treated in this way, via a heating chamber at 150° C. into a double belt press and is pressed at 180° C. under a pressure of 20 bars to the into the composite.

The mechanical testing of test bodies which have been milled from the composite gave in the bending test an E module of 7.3 GPa, a strain at maximum force of 3.2%, an impact strength of 9.5 kJ/m² and water sorption of 0.08%.

The remaining content of free bis(hydroxyethyl)terephthalate (8 hours extraction of milled samples with dioxane, HPLC analysis) is 0.5 mass %. The proportion of the —OCH₃— groups in the treated polytriazine ether (ascertained through GC analysis after fission of the polytriazine ether with mineral acid) is 1.7 mass %.

### EXAMPLE 34

### Production of Paipes

In a Leistritz double worm extruder ZSK 27, L/D=44 with worms running in the same way, dosing device for fibre materials in the 4^{th} cylinder and a decompression zone for vacuum degassing, temperature profile 20/120/120/120/120/120/120/120/140/160° C., the amino resin mould according to Example 1 is dosed into the entry zone at 9 kg, at 4.5 kg/h granulate from ethylene vinyl acetate copolymers (melt index 18 g/10 min at 190° C./2,19 kp, vinyl acetate content 17 mass %) and at 0.75 kg/h wool astonite (Tremin 939, Quarzwerke Austria). After mixing and homogenisation of the components cellulose fibres are added in the 4^{th} cylinder in the form of a line of card in that they are directly unwound from a reel and drawn in by the extruder itself. After dividing the fibres, intensive homogenisation and condensation the mixture is removed as a round hollow profile into a sieve mandrel pipe tool which is heated in multiple stages dielectrically to a temperature gradient of 160-195° C.

If the mixture is removed through a profiled tool 10×4 mm instead of the sieve mandrel pipe tool, standard test rods produced from the profile have in the bending test an E module of 9.2 GPa and an impact strength of 12 kJ/m².

### EXAMPLE 35

### Production of Injection Moulded Forming Components

35.1 Production of the Mould

The following are dosed into the entry zone of a Leistritz double worm extruder ZSK 27, L/D=44, with worms running in the same way, side flow dosing device for media in powder form in the 7ₜₕ cylinder and a decompression zone for vacuum degassing, temperature profile 20/120/120/120/120/120/120/120/120/100° C.: at 7.5 kg/h the polytriazine ether according to Example 1, at 1.5 kg/h glass fibre shavings (amino silane sizing, fibre cross-section 17 μm, fibre length 3 mm) and at 0.5 kg/h customary nitrile rubber. By means of the side flow dosing device in the 7^{th} cylinder a mixture of 20 mass % zeolite (molecular sieve 5A, UOP GmbH) and 80 mass % kaoline TEC 2 (Quarzwerke, Austria) are added at 1.0 kg/h. After intensive homogenisation the mixture is removed and granulated.

35.2 Production of Forming Components by Means of Injection Moulding Technology

The granulate according to 4.1 is processed with an injection moulding machine into composite plates. A temperature of 110° C. is set in the feed component. The temperature of the injection moulding chamber is about 150° C. and an injection pressure of about 100 N/cm² is set. After a standing time of 5 min the workpiece is hardened and can be removed after cooling.

The composite plates formed have scratch resistant upper surfaces and are steam and chemical resistant. Milled standard rods have in the bending test an E module of 7.8 GPa, an impact strength of 9.7 kJ/m² and a strain of 4.1%.

### EXAMPLE 36

### Production of Fibre Filled Profiled Rods

The following are dosed into the entry zone of a Leistritz double worm extruder ZSK 27, L/D=44, with worms running in the same way, side flow dosing device for media in powder form in the 7^{th} cylinder, a decompression zone for vacuum degassing and a profiled tool 4×10 mm, temperature profile 20/120/120/120/120/120/120/120/140/160° C.: at 6.7 kg/h the polytriazine ether according to Example 1, at 0.7 kg/h styrole maleic acid anhydride copolymers (styrole:MSA=2:1), at 1.3 kg/h cellulose short fibres (3 mm) and at 1.3 kg/h polyamide short fibres (3 mm). By means of the side flow dosing device in the 4^{th} cylinder a Na-montmorillonite modified with amino propyl triethoxy silane is added at 1 kg/h. After intensive homogenisation and condensation the mixture is formed in a profiled opening into a full profile and after hardening is processed through tempering.

Standard test rods cut from the profile provided in the bending test an E module of 10.5 GPa, a strain of 3.7% and an impact strength of 13.1 kJ/m².

### EXAMPLE 37

### Production of a Composite Plate by Means of Low Pressure Process

37.1 Production of the Amino Resin Mould

For the production of the polytriazine ether a mixture of 20 mass % 2,4-bis-methoxymethylamino-6-methyl-1,3,5-triazine and 80 mass % 2,4,6-tris-methoxymethylamino-1,3,5-triazine is used as an etherified precondensate and an oligool based on pentaerythrite (simulsol PTKE, Seppic S.A., France) is used as a diol.

In a laboratory extruder GL 27 D44 (Leistritz) with vacuum degassing, temperature profile 130° C./150° C./190° C./230° C./230° C./230° C./230° C./230° C./230° C./100° C./100° C. the mixture of the etherified precondensate is gravimetrically dosed into the entry funnel at 1.38 kg/h and by means of side flow dosing into the entry zone the oligool based on pentaerythrite at 1.12 kg/h. By means of side flow dosing at 0.1 kg/h a sodium montmorillonite (Sudchemie, Moosburg Germany) treated on the upper surface with Succinic acid is dosed into zone 8 of the extruder. The extrusion is effected with an average standing time of 3 to 4 min. The extruder speed is 150 min⁻¹. The stream of the filled polytrizine ether leaving the extruder is cut in a granulator. The amino resin mould is characterised by a low viscosity at 150° C. of about 100-200 Pas.

37.2 Production of the Composite Plate

In a supply container the amino resin mould according to 6.1 is melted at 150° C. A carbon filment tissue is introduced into the tool with 245 g/m². The tool is tempered to 150° C., closed and a vacuum of 130 mbars is put in place. After opening the injection nozzle the resin flows into the tool wherein after complete impregnation of the fleece after 4 min excess resin is extracted. After a hardening time of 6 min the hardened plate can be removed.

Sample rods milled from the plate have a tensile strength of 230 MPa and an impact strength of 35 kJ/cm².

### EXAMPLE 38

### Production of Endless Fibres

The amino resin mould according to Example 1 is melted in a laboratory extruder and heated to 120° C.

The melt is fed at a constant temperature to the entry opening of a spinning pump. With the spinning pump the pre-pressure necessary for flowing through a melt filter and a spinning outlet with 6 holes is produced. The melt of the polytriazine ether is removed at a removal speed of 1300 m/min into a removal shaft, through which heated nitrogen flows, onto a thread diameter of 8-10 μm and cooled.

After the resin has set the fibres are completely hardened in a second section of the removal shaft in an acid atmosphere (dry HCl) and processed in the usual way. The hardened fibres have a strain of 4.2%.

### EXAMPLE 39

### Production of Amino Resin Glass Fibre Composites

39.1 Production of the Amino Resin Mould

For the production of the polytriazine ether a mixture of 75 mass % 2,4,6-tris-ethoxymethylamino-1,3,5-triazine and 25 mass % of a triazine methyl ether which has been produced from a precondensate of butyroguanamine/melamine 1:5 as an amino triazine component and butyral dehyde/formaldehyde 1:8 as an aldehyde component with an aldehyde/amino triazine ratio 3:1 is used an an etherified precondensate. The diol component forms a mixture of 50 mass % butane diol and 50 mass % of a polypropylene glycol with a molar mass of 500.

The re-etherification and further condensation to the polytriazine ether is performed discontinuously in the measurement kneader (Haake Polylabsystem 540 p). After preheating to 175° C., 45 g of the triazine ether mixture and 35 g of the mixture of the diol components are dosed into the mixing chamber and mixed at a speed of 50 min⁻¹ for 12 min. The alcohol mixture released during the compounding is removed from the mixing chamber by vacuum. After 10 min 5 mass % Na-montmorillonite (Südchemie AG) and 5 mass %, each in relation to the amino triazine mixture, polyamide D1466 (Ems-Chemie) are added and mixed for a further 5 min. The polytriazine ether is removed after cooling and milled in a universal mill 100 UPZ/II (Alpine Hosokawa) with impact disc and 2 mm sieve.

39.2 Production of Plates Reinforced with Endless Glass Fibres

For the production of amino resin plates reinforced with endless glass fibre, 10 deposits of the granulate produced in 2.1 is melted in the laboratory extruder at 195° C. and by means of a wide slot opening is continuously fed to a glass fibre fleece (105 g/m²) moved at 0.8 m/min. Through the impregnation the surface mass of the glass fibre fleece is increased to 155 g/m². The impregnated glass fibre fleece is continuously fed, together with two further glass fibre fleeces treated in this way, via a heating chamber at 155° C. into a double belt press and is pressed at 180° C. under a pressure of 20 bars into the composite.

The mechanical testing of test bodies which have been milled from the composite gave in the bending test an E module of 6.3 GPa, a strain at maximum force of 4.2%, an impact strength of 15 kJ/m² and water sorption of 0.14%.

1-21. (canceled)

22. Amino resin moulding materials for products with improved flexibility comprising mixtures of meltable 20 to 1000 nuclei polytriazine ethers,
wherein polytriazine ethers comprising triazine segments according to the formula 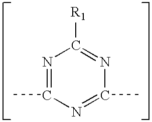
wherein
R₁═—NH₂, —NH—CHR₂—O—R₃, —NH—CHR₂—O—R₄—OH, —OH, phthalimido-, succinimido-, —NH—CHR₂—O—R₄—O—CHR₂—NH—, —NH—CHR₂—NH—, —NH—CHR₂—O—CHR₂—NH—,
R₂═H, C₁-C₇-alkyl;
R₃═C₁-C₁₈-alkyl, H;
R₄═C₂-C₁₈-alkylene, —CH(CH₃)—CH₂—O-_{C2-C12}-alkylene-O—CH₂—CH(CH₃)—, —CH(CH₃)—CH₂—O-_{C2}-C₁₂-arylene-O—CH₂—CH(CH₃)—, —[CH₂—CH₂—O—CH₂—CH₂]ₙ—, —[CH₂—CH(CH₃)—O—CH₂—CH(CH₃)]ₙ—, —[—O—CH₂CH₂—CH₂—CH₂—]ₙ—, —[(CH₂)₂₋₈—O—CO-_{C6-C14}-arylen-CO—O—(CH₂)₂₋₈—]ₙ—, —[(CH₂)₂₋₈—O—CO-_{C2-C12}-alkylen-CO—O—(CH₂)₂₋₈—]ₙ—, wherein n=1 bis 200;
siloxane groups containing sequences of the type 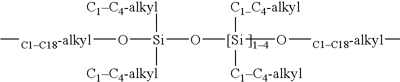
siloxane groups containing polyester sequences of the type —[(X)ᵣ—O—CO—(Y)ₛ—CO—O—(X)ᵣ]—,
wherein 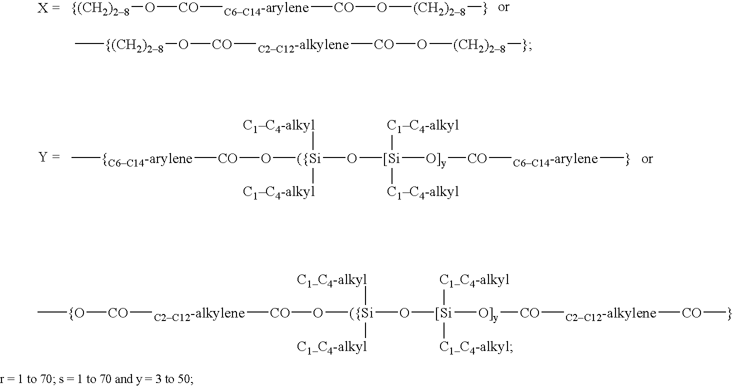
siloxane groups containing polyether sequences of the type 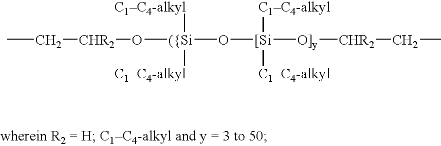
sequences based on alkylene oxide adducts of melamine of the type 2-amino-4,6-di-_{C2-C4}-alkylene-amino-1,3,5-triazine sequences:
phenolic ether sequences based on bivalent phenols and C₂-C₈ diols of the type-_{C2-C8}-alkylene-O-_{C6-C18}-arylene-O-_{C2-C8}-alkylene sequences;
are combined through bridging members —NH—CHR₂—O—R₄—O—CHR₂—NH— and —NH—CHR₂—NH— and optionally —NH—CHR₂—O—CHR₂—NH— to 20 to 1000 nuclei polytriazine ethers with linear and/or branched structure,
wherein the polytriazine ethers the molar ratio of the substituents is R₃:R₄=20:1 to 1:20,
the proportion of the combinations of the triazine segments through bridging members —NH—CHR₃—O—R₄O—CHR₃—NH— is 5 to 95 mol %,
and wherein the amino resin moulding materials optionally contain up to 75 mass % fillers and/or absorber materials, up to 50 mass % further reactive polymers selected from the group consisting of ethylene copolymers, maleic acid anhydride copolymers, modified maleic acid anhydride copolymers, poly(meth)acrylates, polyamides, polyesters and polyurethanes, up to 20 mass % diols according to the formula HO—R₄—OH and up to 5 mass %, stabilisers, UV absorbers, and/or hardening agents.

23. The amino resin moulding materials according to claim 22, wherein the polytriazine ethers are 30 to 300 nuclei polytriazine ethers.

24. The amino resin moulding materials according to claim 22, wherein the polytriazine ethers in the mixtures are polytriazine ethers with R₂═H.

25. A process for producing amino resin moulding materials comprising mixtures of meltable 20 to 1000 nuclei polytriazine ethers,
wherein polytriazine ethers comprising triazine segments according to the formula 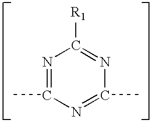
wherein
R₁═—NH₂, —NH—CHR₂—O—R₃, —NH—CHR₂—O—R₄—OH, —OH, phthalimido-. succinimido-, —NH—CHR₂—O—R₄—O—CHR₂—NH—, —NH—CHR₂—NH—, —NH—CHR₂—O—CHR₂—NH—,
R₂═H, C₁-C₇-alkyl;
R₃═C₁-C₁₈-alkyl, H;
R₄═C₂-C₁₈-alkylene, —CH(CH₃)—CH₂—O-_{C2-C12}-alkylene-O—CH₂—CH(CH₃)—, —CH(CH₃)—CH₂—O-_{C2-C12}-arylene-O—CH₂—CH(CH₃)—, —[CH₂—CH₂—O—CH₂—CH₂]ₙ—, —[CH₂—CH(CH₃)—O—CH₂—CH(CH₃)]ₙ—, —[—O—CH₂CH₂—CH₂—CH₂—]ₙ—, —[(CH₂)₂₋₈—O—CO-_{C6-C14}-arylene-CO—O—(CH₂)₂₋₈—]ₙ—, —[(CH₂)₂₋₈—O—CO-_{C2-C12}-alkylene-CO—O—(CH₂)₂₋₈—]ₙ—, wherein n=1 to 200;
siloxane groups containing sequences of the type 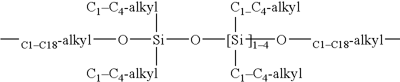
siloxane groups containing polyester sequences of the type —[(X)ᵣ—O—CO—(Y)ₛ—CO—O—(X)ᵣ]—,
wherein 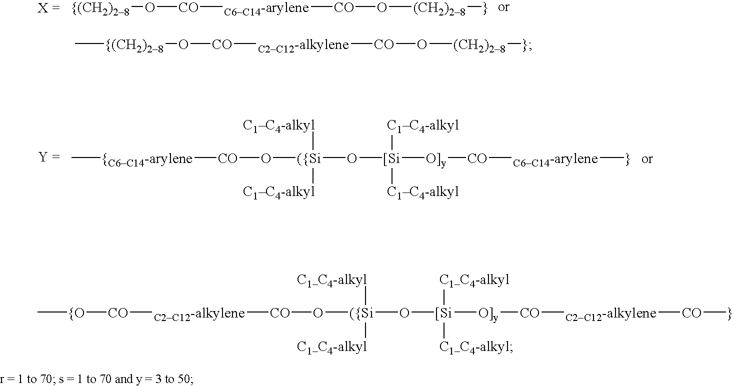
siloxane groups containing polyether sequences of the type 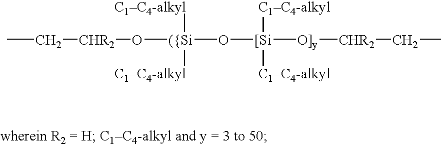
sequences based on alkylene oxide adducts of melamine of the type 2-amino-4,6-di-_{C2-C4}-alkylene-amino-1,3,5-triazine sequences:
phenolic ether sequences based on bivalent phenols and C₂-C₈ diols of the type -_{C2-C8}-alkylene-O-_{C6-C18}-arylene-O-_{C2-C8}-alkylene sequences;
are combined through bridging members —NH—CHR₂—O—R₄—O—CHR₂—NH— and —NH—CHR₂—NH— and optionally —NH—CHR₂—O—CHR₂—NH— to 20 to 1000 nuclei polytriazine ethers with linear and/or branched structure,
wherein in the polytriazine ethers the molar ratio of the substituents is R₃:R₄=20:1 to 1:20,
the proportion of the combinations of the triazine segments through bridging members —NH—CHR₃—O—R₄—O—CHR₃—NH— is 5 to 95 mol %,
and wherein the amino resin moulding materials can contain up to 75 mass % fillers, up to 50 mass % further reactive polymers of the type ethylene copolymers, maleic acid anhydride copolymers, modified maleic acid anhydride copolymers, poly(meth)acrylates, polyamides, polyesters and/or polyurethanes, up to 20 mass % diols of the type HO—R₄—OH, and up to 2 mass % stabilisers, UV absorbers and/or auxiliary substances,
comprising the steps of etherifying precondensates of C₁-C₈ aldehydes and triazine derivatives of the structure 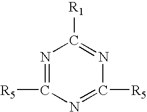
R₁═—NH₂, —NH—CHR₂—OH, —OH, phthalimido-. succinimido-,
R₂═H, C₁-C₇ -alkyl;
R₅═—NH—CHR₂—OH
through conversion with Cl-C₈ alcohols in neutral to weak acid medium at 25 to 150° C. and 0.1 to 5 bars; conditioning the substituted triazine derivatives with standing times of 5 to 15 min at 150 to 250° C. and 0.1 to 15 bars; separating any salts that are formed while maintaining a pH value of 7 to 10, wherein the melt of the amino triazine ethers at 70 to 150° C. are present in a 70 to 150 mass %, in relation to C₃ to C₆ alcohols which are dissolved; separating insoluble proportions off after cooling to 15 to 40° C., evaporating the added C₃ to C₆ alcohols at 70 to 140° C. to a remaining content of 5 to 20 mass % to provide C₁-C₈-alkyl-oxa-C₁-C₈-alkylene-amino-substituted triazine derivatives;
reacting the C₁-C₈-alkyl-oxa-C₁-C₈-alkylene-amino-substituted triazine derivatives through partial re-etherification with diols of the type HO—R₄—OH and/or partial conversion with bisepoxides of the type H₂C—CH—R₆—CH—CH₂ 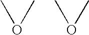
Wherein R₄ is selected from the group consisting of
C₂-C₁₈-alkylene, —[CH₂—CH₂—O—CH₂—CH₂]ₙ—, —[CH₂—CH(CH₃)—O—CH₂—CH(CH₃)]ₙ—, —[—O—CH₂—CH₂—CH₂—CH₂—]ₙ—, —[(CH₂)₂₋₈—O—CO-_{C6-C14}-arylene-CO—O—(CH₂)₂₋₈—]ₙ—, —[(CH₂)₂₋₈—O—CO-_{C2-C12}-alkylene-CO—O—(CH₂)₂₋₈—]ₙ—, wherein n=1 to 200;
siloxane groups containing sequences of the type 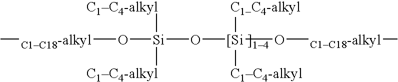
siloxane groups containing polyester sequences of the type —[(X)ᵣ—O—CO—(Y)ₛ—CO—O—(X)ᵣ]—,
wherein
X═{(CH₂)₂₋₈—O—CO-_{C6-C}₁₄-arylene-CO—O—(CH₂)₂₋₈—} or —{(CH₂)₂₋₈—O—CO-_{C2-C12}-alkylene-CO—O—(CH₂)₂₋₈—}; 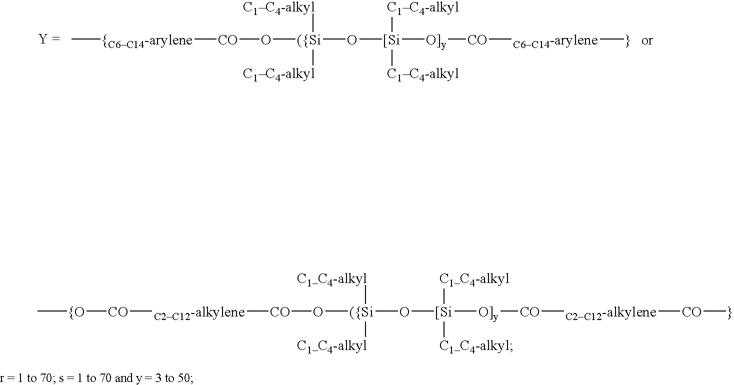
siloxane groups containing polyether sequences of the type 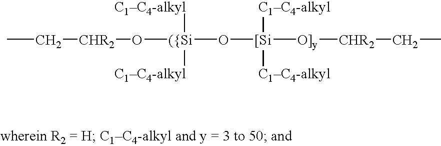
sequences based on alkylene oxide adducts of melamine of the type 2-amino-4,6-di-_{C2-C4}-alkylene-amino-1,3,5-triazine sequences:
phenolic ether sequences based on bivalent phenols and C₂-C₈ diols of the type-_{C2-C8}-alkylene-O-_{C6-C18}-arylene-O-_{C2-C8}-alkylene sequences;
and R₆═—CH₂—O-_{C2-C12}-alkylene-O—CH₂—, —CH₂—O-_{C6-C14}-arylene-O—CH₂—,
to provide a reaction product containing 70 mass % C₅-C₁₈ alcohols, converted into the corresponding substituted triazine derivatives with standing times of 1 to 60 min with distilling of C₁-C₈ alcohols at 60 to 250° C./0.05 to 1 bar wherein through the molar ratio C₁-C₈-alkyl-oxa-C₁-C₈-alkylene-amino groups/diol used and/or bisepoxide used of 20:1 to 1.1:1 a partial re-etherification of the C₁-C₈-alkyl ether groups of the C₁-C₈-alkyl-oxa-C₁-C₈ alkylene amino triazines is achieved,
further condensing the amino triazine ethers to polytriazine ethers in the melt obtained which contains etherified amino triazine derivatives and proportions of polytriazine ethers and unconverted or unseparated diol and furthermore can contain C₅-C₁₈ alcohols is dosed into a kneader, converted with a standing time of 2 to 12 min at 140 to 220° C. with degassing and the polytriazine ethers are removed and granulated wherein the melt, before dosing into a kneader, are optionally subjected to tempering of 20 to 120 min at 70 to 140° C., up to 75 mass % fillers, further reactive polymers selected from the group consisting of ethylene copolymers, maleic acid anhydride copolymers, modified maleic acid anhydride copolymers, poly(meth)acrylates, polyamides, polyesters and polyurethanes and up to 2 mass %, each in relation to the polytriazine ethers, stabilisers, and/or UV absorbers are added to the melt and optionally subjecting the melt to a melt filtration before removal.

26. The process for the production of amino resin moulding materials according to claim 25, wherein as ionic catalysts and/or for the neutralisation of the reaction deposit anorganic or organic acids, bases, ion exchanging resins and/or acid zeolites are used.

27. The process for the production of amino resin moulding materials according to claim 25, wherein the etherification of the precondensates with C₁-C₈ alcohols is performed in the presence of 10 to 300 mass %, in relation to the dry substance of the precondensates used, molecular sieveing.

28. The process for the production of amino resin moulding materials according to claim 25, wherein the partial re-etherification of the C₁-C₈-alkyl-oxa-C₁-C₈-alkylene-amino-substituted triazine derivatives is performed catalytically in the presence of strong acids at temperatures in the range of 100-175° C.

29. The process for the production of amino resin moulding materials according to claim 25, wherein the process of partial re-ehterisation of the C₁-C₈-alkyl-oxa-C₁-C₈-alkylene-amino-substituted triazine derivatives is performed thermally at temperatures in the range of 150-250° C.

30. The process for the production of amino resin moulding materials according to claim 25, wherein the process for the further condensation of the amino triazine ethers to polytriazine ethers mixtures of products of different initial products or mixtures of products C₁-C₈-alkyl-oxa-C₁-C₈-alkylene-amino-substituted triazine derivatives which have not been re-etherified are used.

31. The process for the production of amino resin moulding materials according to claim 25, wherein all steps of the process are performed one after the other in a reaction installation.

32. Melt adhesives, plates, pipes, profiles, injection moulded components, fibres, foams, impregnation resins, paint resins or laminating resins, or micro-capsules comprising the amino resin moulding materials according to claim 23.

33. Amino resin products with improved flexibility, comprising the amino resin moulding materials according to claim 22.

34. The amino resin products according to claim 33, wherein the amino resin products are semifinished products produced through melt processing, wherein the products are selected from the group consisting of plates, pipes, profiles, coatings, foams, fibres, forming substances, injection moulded components, and components produced from fibres according to winding, braiding or pultrusion technology and subsequent resin impregnation.

35. Amino resin products according to claim 33, further comprising fillers and adsorber materials selected from the group consisting of Al₂O₃, Al(OH)₃, SiO₂, barium sulphate, calcium carbonate, glass balls, silica, mica, quartz dust, slate dust, micro hollow spheres, carbon black, talc, layer silicates, molecular sieves, stone dust, wood flour, cellulose, cellulose derivatives, and combinations thereof.

36. The amino resin products according to claim 35, wherein the silicates are selected from the group consisting of bentonite, kaolinite, muscovite, hectorite, fluorohectorite, kanemite, revdite, grumantite, Ilerite, saponite, beidelite, nontronite, stevensite, laponite, taneolite, vermiculite, halloysite, volkonskoite, magadite, rectorite, kenyaite, sauconite, boron fluorophlogopite and synthetic smectites.

37. The amino products according to claim 36, wherein the silicates are adsorber material layer silicates selected from the group consisting of montmorillonite, bentonite, hectorite, molecular sieves of the types A, X, Y, or 5A, adsorbers with a silicon base, micro hollow spheres, cellulose and cellulose derivatives.

38. The amino resin products according to claim 33, further comprising reinforcement fibres selected from the group consisting of glass fibres, carbon fibres, cellulose fibres, flax, jute, kenaf, wood fibres, polyacryl nitrile fibres, polyvinyl alcohol fibres, polyvinyl acetate fibres, polypropylene fibres, polyester fibres and polyamide fibres.

39. A process for producing amino resin products with improved flexibility, comprising melting amino resin moulding materials comprising mixtures of meltable 20 to 1000 nuclei polytriazine ethers,
wherein in the polytriazine ethers the triazine segments 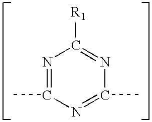
R₁═—NH₂, —NH—CHR₂—O—R₃, —NH—CHR₂—O—R₄—OH, —OH, phthalimido-. succinimido-, —NH—CHR₂—O—R₄—O—CHR₂—NH—, —NH—CHR₂—NH—, —NH—CHR₂—O—CHR₂—NH—,
R₂═H, C₁-C₇-alkyl;
R₃═C₁-C₁₈-alkyl, H;
R₄═C₂-C₁₈-alkylene, —CH(CH₃)—CH₂—O-_{C2-C12}-alkylene-O—CH₂—CH(CH₃)—, —CH(CH₃)—CH₂—O-_{C2-C12}-arylene-O—CH₂—CH(CH₃)—, —[CH₂—CH₂—O—CH₂—CH₂]ₙ—, —[CH₂—CH(CH₃)—O—CH₂—CH(CH₃)]ₙ—, —[—O—CH₂—CH₂—CH₂—CH₂—]ₙ—, —[(CH₂)₂₋₈—O—CO-_{C6-C14}-arylene-CO—O—(CH₂)₂₋₈—]ₙ—, —[(CH₂)₂₋₈—O—CO-_{C2-C12}-alkylene-CO—O—(CH₂)₂₋₈—]ₙ—, wherein n=1 to 200;
siloxane groups containing sequences of the type 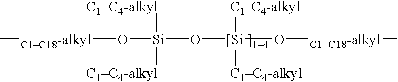
siloxane groups containing polyester sequences of the type —[(X)ᵣ—O—CO—(Y)ₛ—CO—O—(X)ᵣ]—,
wherein
X═{(CH₂)₂₋₈—O—CO-_{C6-C14}-arylene-CO—O—(CH₂)₂₋₈—} or —{(CH₂)₂₋₈—O—CO-_{C2-C12}-alkylene-CO—O—(CH₂)₂₋₈—}; 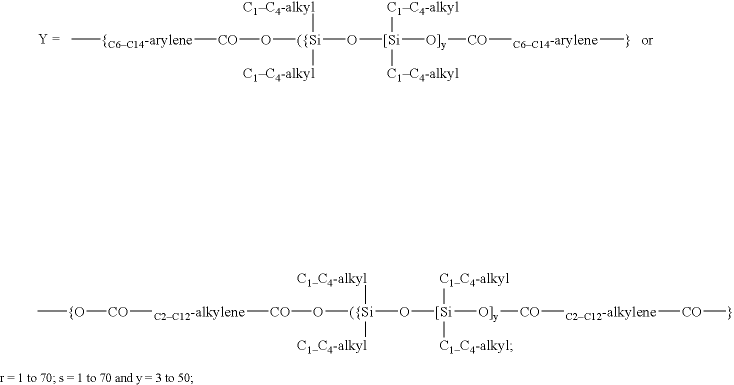
siloxane groups containing polyether sequences of the type 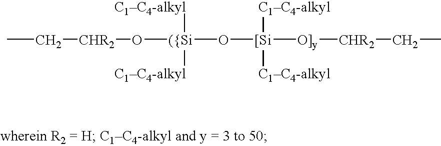
sequences based on alkylene oxide adducts of melamine of the type 2-amino-4,6-di-_{C2-C4}-alkylene-amino-1,3,5-triazine sequences:
phenolic ether sequences based on bivalent phenols and C₂-C₈ diols of the type-_{C2-C8}-alkylene-O-_{C6-C18}-arylene-O-_{C2-C8}-alkylene sequences;
are combined through bridging members —NH—CHR₂—O—R₄—O—CHR₂—NH— und —NH—CHR₂—NH— and optionally —NH—CHR₂—O—CHR₂—NH— to 20 to 1000 nuclei polytriazine ethers with linear and/or branched structure,
wherein in the polytriazine ethers the molar ratio of the substituents is R₃:R₄=20:1 to 1:20,
the proportion of the combinations of the triazine segments through bridging members —NH—CHR₃—O—R₄—O—CHR₃—NH— is 5 to 95 mol %,
and wherein the amino resin moulding materials can contain up to 75 mass % fillers and/or adsorber materials, up to 50 mass % further reactive polymers of the type ethylene copolymers, maleic acid anhydride copolymers, modified, maleic acid anhydride copolymers, poly(meth)acrylates, polyamides, polyesters and/or polyurethanes, up to 20 mass % diols of the type HO—R₄—OH, and up to 2 mass % stabilisers, UV absorbers, hardening agents and/or auxiliary substances,
in continuous kneaders at mass temperatures of 105 to 260° C. and standing times of 2 to 12 min and with hardening of the polytriazine ethers according to usual processing methods for thermoresin polymers
A) placing as a melt on a smoothing device and taken out as a plate by means of conveyor belts and cut or sealed on surface guides made from metallised films, synthetic films, paper guides or textile guides and removed and processed as multicomponent composites, or
B) taking out via a profiled opening and removed, cut and processed as a profile or plate material, or
C) taking out via an annular opening, removed with pressing of air as a pipe, removed, cut and processed, or
D) after dosing of blowing agents removed taking out via a wide slot opening and removed as a foamed plate material, or
E) taking out via the wide slot opening of a pipe coating installation and sealed in a fuisible manner onto the rotating pipe, or
F) processing into injection moulded components in injection moulding machines, having three zone worms with a worm length of 18 to 24 D, high injection speeds and with tool temperatures of 70 to 150° C., or
G) extruding in melt spinning installations by means of melt pump through the capillary tool into the blow shaft and taken out as threads or after the melt-blow process separated off as fibres or after the rotation spinning process taken out as a melt into a shear field chamber with organic dispersing agents with the formation of fibre fibrides and further processed in subsequent devices, or
K) melt impregnating component blanks produced according to the winding process, braiding process or pultrusion process,
and optionally for complete hardening the products subjecting to subsequent thermal processing at temperatures of 180 to 280° C. and standing times of 20 to 120 min.

40. The process for producing amino resin products according to claim 39, wherein the polytriazine ethers contained in the amino resin moulding materials used are 30 to 300 nuclei polytriazine ethers.

41. The process for producing amino resin products with improved flexibility according to claim 39, wherein the polytriazine ethers contained in the amino resin moulding materials used are polytriazine ethers with R₂═H.

42. The process for producing amino resin products with improved flexibility according to claim 39, wherein the hardening agents contained in the amino resin moulding materials used are weak acids selected from the group consisting of:
blocked sulphonic acids,
aliphatic C₄-C₁₈ carbonic acids,
alkali salts or ammonium salts of phosphoric acid,
C₁-C₁₂ alkyl esters or C₂-C₈ hydroxyalkyl esters of C₆-C₁₄ aromatic carbon acids or anorganic acids,
salts of melamine or guanamines with C₁-₁₈ aliphatic carbonic acids,
anhydrides, semi-esters or semi-amides of C₄-C₂₀ dicarbonic acids,
semi-esters or semi-amides of copolymers of ethylenically unsaturated C₄-C₂₀ dicarbonic acid anhydrides and ethylenically unsaturated monomers of the type C₂-C₂₀ olefines and/or C₈-C₂₀ vinyl aromates, and
salts of C₁-C₁₂-alkyl amines or alkanol amines with C₁-C₁₈ aliphatic, C₆-C,₄-aromatic or alkyl aromatic carbonic acids as well as anorganic acids of the type hydrochloric acid, sulphuric acid or phosphoric acid.

43. The process for producing amino resin products according to claim 39, wherein the production of fibre fibrides from the amino resin moulding materials is effected through
introducing the melt via entry openings at melt temperatures of 160 to 220° C. into a shear field chamber which contains high boiling organic dispersion agent heated to 150 to 210° C., preferably paraffin oil or engine oil, wherein acid gases, preferably chlorohydrogen or sulphur dioxide are introduced into the shear field chamber, and wherein the melt stream leaving the entry opening is extended and divided through the oil whirled about by the rotor with the formation of fibres,
conveying the dispersion of the fibre fibrides formed in organic dispersion agent into a sieve separator with simultaneous extraction of the high boiling dispersion agent with low boiling hydrocarbons, preferably hexane or heptane,
removing the fibre fibride short fibre fleece and optionally subsequent thermal treating of the short fibre fleece at temperatures of 180 to 210° C. and standing times of 40 to 120 min.

44. Foam plates as isolation components, in the form of plates as panelling elements, in the form of pipes and hollow profiles in ventilation technology, in the form of injection moulded components as functional components, and fibres for the production of electro-isolation papers, fire protection clothing, clothing for high working temperatures, fire protection blankets, filter fleeces, felts for paper machines and vehicle and machine isolation covers, or containers or profiles according to the winding, braiding or pultrusion process comprising the amino resin products according to claim 33.
